(19) United States
(12) Patent Application Publication
(10) Pub. No.: US 2025/0053066 A1
(43) Pub. Date: Feb. 13, 2025

(54) IMAGING SYSTEM WITH VARIABLE APERTURE

(71) Applicant: Glass Imaging Inc., Los Altos, CA (US)

(72) Inventors: Ziv Attar, Los Altos, CA (US); George Douglas MacEwen, Cupertino, CA (US); Cole Alexander Cogswell, Mountain View, CA (US)

(21) Appl. No.: 18/796,976

(22) Filed: Aug. 7, 2024

Related U.S. Application Data
(60) Provisional application No. 63/531,055, filed on Aug. 7, 2023.

(51) Int. Cl. G03B 9/02

(52) U.S. Cl. CPC G03B 9/02

(57) ABSTRACT

An imaging system may include an image sensor. The imaging system may include two sheets along an optical path of the imaging system, where the two sheets are substantially transparent. The imaging system may include a deformable layer between the two sheets. The deformable layer forms an aperture and/or filter. The imaging system may include a motor configured to adjust a distance between the two sheets, where the size of the aperture is based on the distance between the two sheets.

### CROSS REFERENCE TO RELATED APPLICATION

This application claims priority to, and the benefit of, U.S. Provisional Application No. 63/531,055, “Mechanical Improvements for Camera Module,” filed on Aug. 7, 2023, the subject matter of which is incorporated herein by reference in its entirety.

### FIELD OF ART

The disclosure generally relates to the field of imaging systems and, in particular, to imaging systems with variable apertures.

### BACKGROUND

Many cameras include an iris diaphragm to control the size of the camera aperture. Iris diaphragms usually include a series of overlapping plates that can be adjusted to change the size of a central hole. Adjusting these plates can either constrict or widen the aperture, allowing for control over the light's intensity and focus. However, by forming the camera aperture with these overlapping plates, the resulting aperture shape includes corners that can cause diffraction spikes and affect the shape of the bokeh in an image. Thus, an iris diaphragm cannot form an aperture with a smooth shape (e.g., a circle or oval), especially across the range of aperture size settings.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIGS. 1A and 1B illustrate an imaging system contained in a mobile device, according to one or more embodiments.

FIGS. 2A-2C illustrate the imaging system capturing images of different portions of a view of an external environment, according to one or more embodiments.

FIG. 2D illustrates the images of the portions of the view, according to one or more embodiments.

FIG. 2E illustrates an image of the view of the external environment formed from the images in FIG. 2D, according to one or more embodiments.

FIG. 3A is a diagram of an imaging system with an adjustable aperture, according to one or more embodiments.

FIG. 3B is a diagram of an example deformable layer that includes a first portion of substantially opaque material and a second portion that is substantially transparent, according to one or more embodiments.

FIGS. 3C-3D are diagrams of the adjustable aperture module of FIG. 3A, according to one or more embodiments.

FIGS. 4A-4C are diagrams of an adjustable aperture module with a protrusion, according to one or more embodiments.

FIGS. 5-6 are diagrams of other adjustable aperture modules with protrusions, according to one or more embodiments.

FIGS. 7A-7C are diagrams of an adjustable aperture module with three sheets, according to one or more embodiments.

FIG. 8 includes diagrams of an adjustable aperture module with three sheets and a protrusion, according to one or more embodiments.

FIG. 9A is another diagram of a deformable layer, according to one or more embodiments.

FIGS. 9B-9C are diagrams of an adjustable aperture module with the deformable layer of FIG. 9A, according to one or more embodiments.

FIGS. 10A-10D are diagrams of an adjustable aperture module with a wall, according to one or more embodiments.

FIGS. 11A-11D are diagrams of an adjustable aperture module with a set of voice coil motors, according to one or more embodiments.

FIG. 12 is an example of an adjustable aperture and filter module with a filter on a portion of the second sheet, according to one or more embodiments.

FIG. 13A includes cross sectional diagrams of an adjustable aperture and filter module, where the second portion of the deformable layer includes a substantially transparent sub-portion and a semi-transparent sub-portion, according to one or more embodiments.

FIG. 13B includes transparency plots for the corresponding diagrams in FIG. 13A, according to one or more embodiments.

FIG. 14A includes cross sectional diagrams of an adjustable filter module with the deformable layer including a substantially transparent portion and a semi-transparent portion, according to one or more embodiments.

FIG. 14B includes transparency plots for the corresponding diagrams in FIG. 14A, according to one or more embodiments.

FIG. 15 includes cross sectional diagrams of an adjustable filter module with the deformable layer including liquid crystal, according to one or more embodiments.

FIG. 16 includes cross sectional diagrams of an adjustable aperture and filter module, according to one or more embodiments.

FIG. 17 includes cross sectional diagrams of another imaging system, according to one or more embodiments.

FIG. 18 is a diagram of an example sheet (of an adjustable aperture module) that includes integrated components, according to one or more embodiments.

FIG. 19 is an array of sheets configured for wafer manufacturing, according to one or more embodiments.

FIG. 20 includes diagrams of variable optical apertures formed by strips of substantially opaque elastic material, according to one or more embodiments.

FIGS. 21-26 are diagrams of example strips of elastic materials that may be used to form a variable aperture, according to one or more embodiments.

FIG. 27 is a block diagram illustrating components of an example machine able to read instructions from a machine-readable medium and execute them in a processor (or controller), according to an embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Introduction

Imaging systems may include an adjustable aperture module that can adjust the shape or size of an aperture during operation of the imaging system. More specifically, an adjustable aperture module includes a deformable layer between two (e.g., rigid, and substantially transparent) sheets. The deformable layer forms an aperture (e.g., it includes a substantially opaque material with a hole). The shape and size of the aperture can be changed by changing the distance between the sheets. For example, applying a force to reduce the sheet distance may deform the deformable layer such that the aperture size grows (or shrinks depending on the material and design). Removing the force, or applying the force in the opposite direction, may cause the aperture size to shrink (or grow). The variable aperture size and shape can be modeled as a function of the displacement caused by the changing the distance between the sheets. Among other advantages, an adjustable aperture module enables an imaging system to quickly change the shape or size of the aperture during operation.

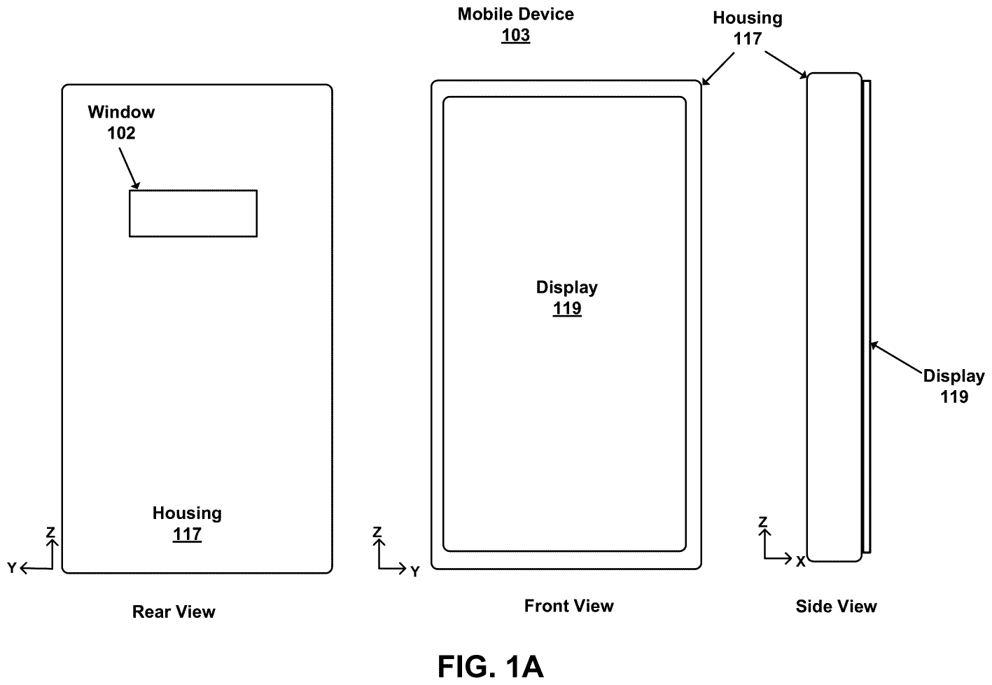

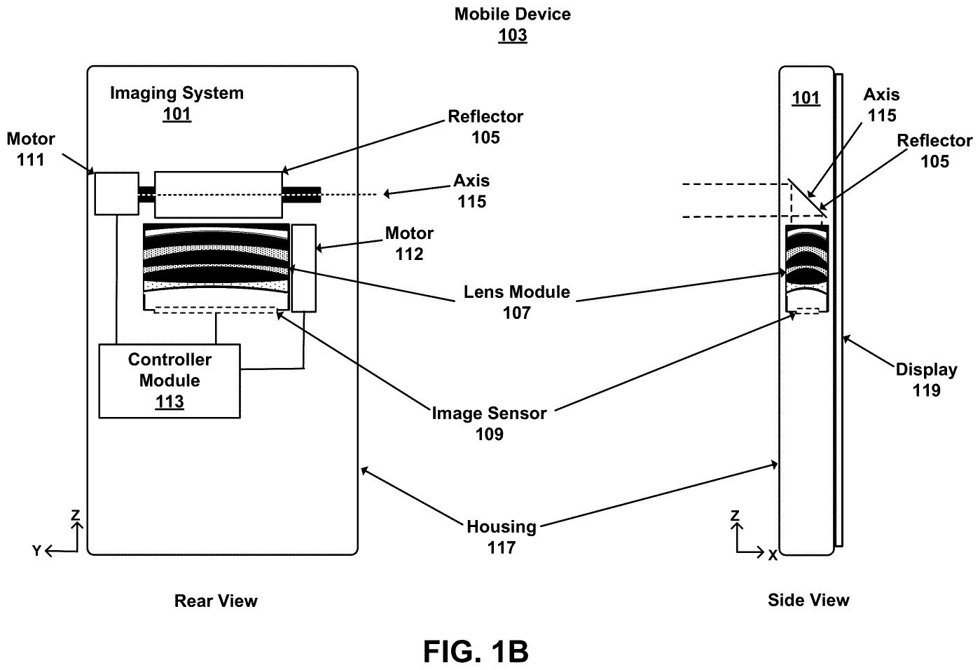

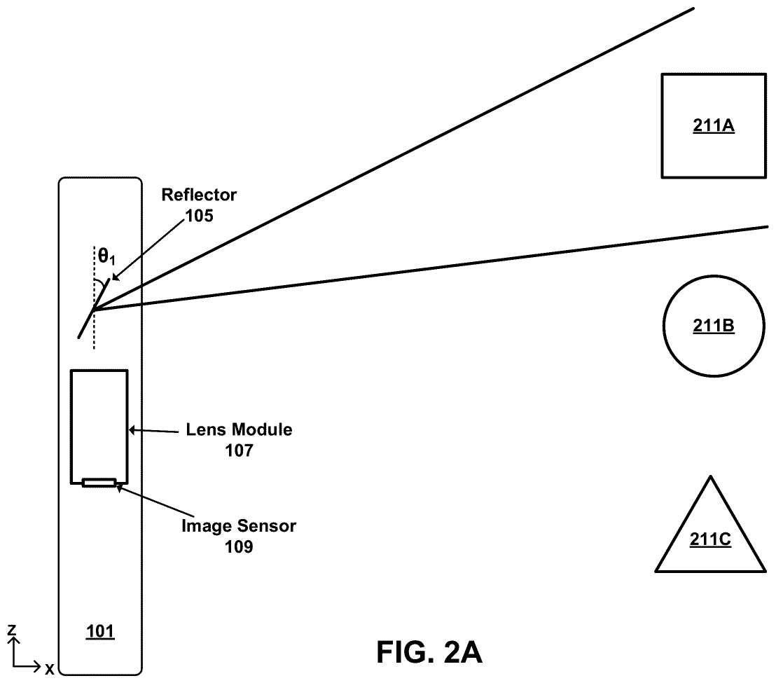

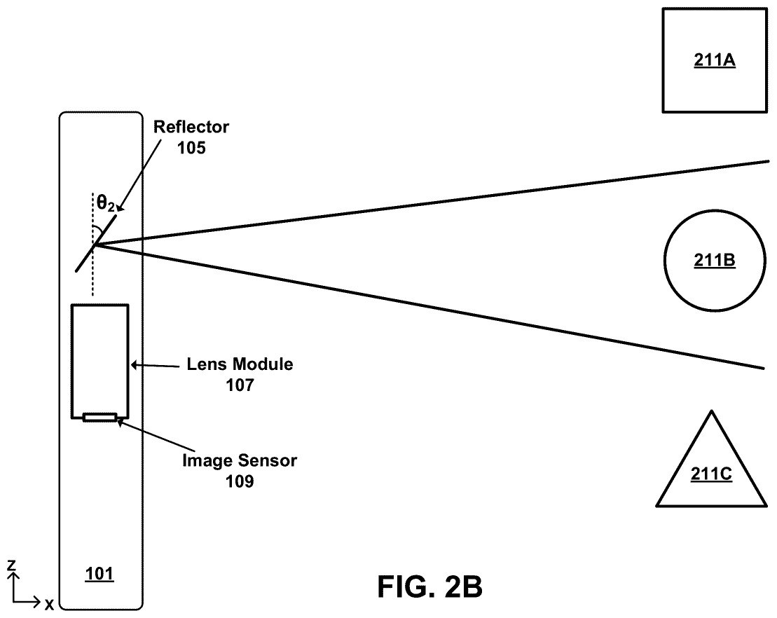

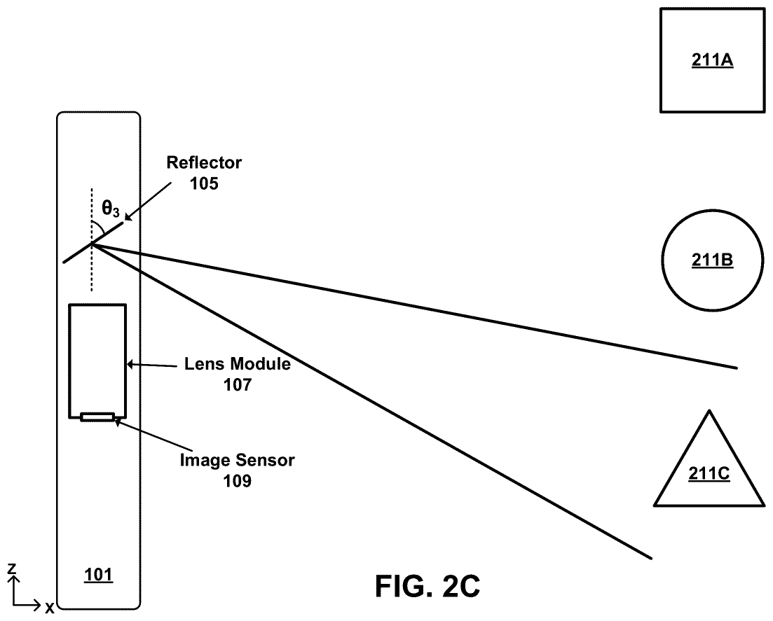

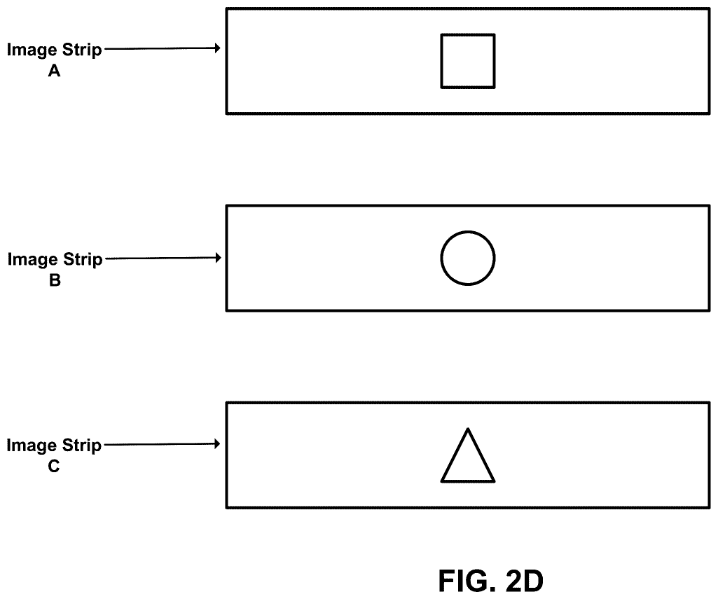

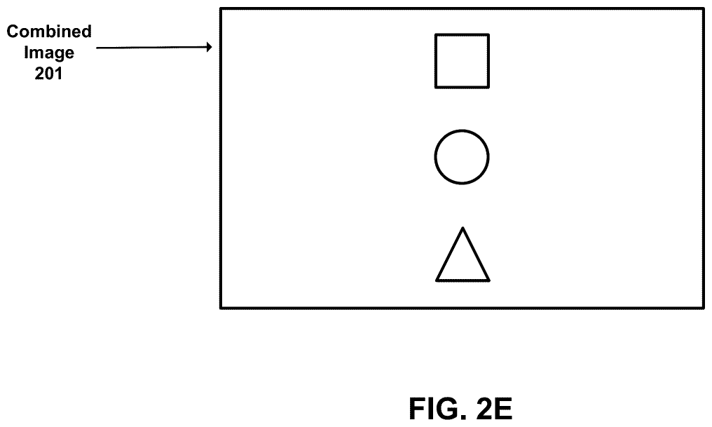

Adjustable aperture modules are further described with reference to subsequent figures. But first, FIGS. 1A-2E and their descriptions describe example imaging systems with a reflector. The adjustable aperture modules described herein may be implemented in a wide variety of different imaging systems, such as the imaging systems described with reference to FIGS. 1A-2E. For example, an adjustable aperture module may be placed: (a) between the reflector (e.g., 105) and the housing window (e.g., 102) or (b) between the reflector (e.g., 105) and the lens module (e.g., 107).

### Example Imaging Systems

FIGS. 1A-1B (“FIG. 1” collectively) illustrate an example imaging system 101 contained in an example mobile device 103, according to an embodiment. Specifically, FIG. 1A illustrates a front, rear, and side view of the mobile device 103, and FIG. 1B illustrates a cross-sectional rear view and cross-sectional side view of the mobile device 103. The mobile device 103 includes the imaging system 101, a housing 117 with a window 102, and a display 119. The imaging system 101 includes a rotatable reflector 105, a motor 111, a motor 112, a lens module 107 (also referred to as a lens design), an image sensor 109, and a controller module 113.

The reflector 105 directs light passing through the window 102 downward towards the lens module 107. The lens module 107 focuses light onto the image sensor 109. The motor 111 rotates the reflector 105 about axis 115, which is substantially parallel (e.g., within a three degrees) to the image sensor plane. Rotating the reflector 105 allows the reflector 105 to direct light from different portions of the external environment towards the image sensor 109. The controller 113 is electrically coupled to the image sensor 109 and the motor 111. To form an image of the external environment, the imaging system 101 captures images of portions of a view of the external environment while rotating the reflector 105. The rotation of the reflector 105 from an initial angular position to a final angular position may be referred to as a scan. The sequence of captured images contains information of several adjacent portions of the environment and, after combining (e.g., stitching or fusing) the images together, the imaging system 101 forms a larger image of the external environment with a predetermined aspect ratio.

The housing 117 contains one or more of the components of the imaging system 101. Locations and orientations of the imaging system components may be described relative to the housing 117 and a housing window 102. For example, the housing 117 is defined by multiple walls that contain the imaging system 101, and one of the walls includes a housing window 102 with a plane, for example, defined by a boundary of the window 102. The plane may be parallel to an yz- (or yz-) plane in a three-dimensional reference system. The housing 117 may have a low profile along an axis perpendicular to the plane of the window 102 (e.g., along the x-axis). The length of the housing along the x-axis may be referred to as the thickness of the housing 117 and may range from, for example, 5 to 15 millimeters. In embodiments where the housing 117 is part of a mobile device 103, the window plane may be parallel to a display 119 of the mobile device 103. Unlike conventional imaging systems, the image sensor surface does not face the window plane. For example, the image sensor surface is perpendicular to the window plane (e.g., parallel to the xy-plane) and is outside the boundary of the window 102. Due to this, the reflector 105 may be aligned with the window 102 to direct light propagating through the window 102 to the image sensor plane. The lens module 107 may be between the reflector 105 and the image sensor 109. An aperture plane may be between the reflector 105 and the lens module 107 and may be perpendicular to the window plane and parallel to the image sensor plane. The reflector allows the optical path of the imaging system 101 to be folded into the yz-plane. This folding allows the optical path to increase beyond the limit of the housing's thickness and into the housing's width (e.g., length along the y-axis) and height (e.g., length along the z-axis), which are typically larger than its thickness. Thus, the reflector, the image sensor, and/or an aperture of the lens module 107 may have aspect ratios that are not 1:1, and their long axes may be parallel to each other.

The terms “parallel” and “perpendicular” may refer to components being substantially parallel or substantially perpendicular (e.g., within three degrees) since manufacturing components that are perfectly parallel or perpendicular may be practically difficult to achieve.

The image sensor 109 is an imaging device that captures images of portions of the external environment. Examples of the image sensor 109 include a CCD sensor and a CMOS sensor. As illustrated in FIG. 1, the image sensor surface may lie in the xy-plane relative to an xy-plane of the mobile device 103 and the image sensor surface faces in a perpendicular direction (along the z-axis) from the xy-planar surface. Due to this positioning, the sensor plane of the image sensor 109 does not face the view of the external environment. By placing the image sensor 109 in the xy-plane, the size of the image sensor 109 can be larger than image sensors in conventional cameras. The smaller dimension of the image sensor plane (along the x-axis) may be limited by the mobile device thickness while the longer dimension (along the y-axis) may be limited by the mobile device width, which may be many centimeters long. This allows the image sensor 109 to have a high aspect ratio, such as ratio greater than 17:9 (e.g., 1:10). Conventional cameras produce image of scenes with aspects ratios that are not as high. Due to the high aspect ratio of the image sensor 109, the image sensor 109 may create narrow images (“image strips”) that correspond to a narrow view of the scene. For conventional imaging systems in mobile devices, the size of the image sensor may be limited by the focal length of the camera lens. However, by changing the location and orientation of the image sensor 109 as described herein, the image sensor size may be larger than image sensors in conventional imaging systems with a same or similar housing.

As described above, the reflector 105 (also referred to as a scanning mirror) is an optical component that rotates about axis 115 to direct light to the image sensor 109. Generally, axis 115 is substantially parallel to a long dimension of the image sensor plane and the reflector 105 is centered on window 102. If the plane of the window 102 (e.g., the yz-plane) is perpendicular to the plane of the image sensor 109 (e.g., the xy-plane), the reflector 105 may direct light at around a 45-degree position relative to the image sensor plane to direct light towards the image sensor 109. Due to the high aspect ratio of the image sensor 109, the reflector 105 may also have a high aspect ratio to ensure light is reflected to the entire surface of the image sensor 109. The reflector 105 is illustrated in FIG. 1B as having a rectangular plane, however other shapes are possible, such as concave or convex shapes (e.g., which may be used to expand or shrink the field of view).

The reflector 105 is described herein in terms of ‘directing’ light, however this is for ease of description. The reflector 105 may optically direct, widen, slim, reflect, diffract, refract, disperse, amplify, reduce, combine, separate, polarize, or otherwise change properties of the light as it propagates in the imaging system 101. To do this, the reflector 105 may include reflective coatings, metalized features, optical gratings, mirrors, prismatic structures, Fresnel structures, corner reflectors, retroreflectors, and the like on one or more of its surfaces.

The lens module 107 includes one or more optical components and is designed to form an image on the image sensor 109. The lens module 107 may spread, focus, redirect, and otherwise modify the light passing through it. The lens module 107 may be as simple as a single lens or it may include additional optical components, such as diffusers, phase screens, beam expanders, mirrors, and lenses (e.g., anamorphic lenses). In some embodiments, the entrance pupil of the lens module 107 is adjacent to the reflector 105. This may allow the reflector 105 to have a smaller size. In some embodiments, the lens module 107 include a non-symmetrical aperture with one large and one small axis (stretching an axis may be used in devices that have dimension constrains, like smartphones, and in those cases the aperture can be much larger if it isn't symmetrical).

Because of the high aspect ratio of the image sensor 109, the lens module 107 may be designed and manufactured to be non-circular or non-symmetric and follow the dimension of the image sensor 109 in the terms of its aperture. Using a lens module 107 with a non-symmetrical aperture may allow it to fit in the mobile device housing 117. Furthermore, the focal length of the lens module 107 may be different in the x- and y-directions. In some embodiments, this results in the imaging system 101 not preserving the aspect ratio, so, for example, a 4:3 scene may be imaged by an image sensor that is 8:3. One or more of the optical components of the lens module 107 may have surfaces with cylindrical symmetry but the apertures of other components may be rectangular or another elongated shape. The lens module 107 may be manufactured using wafer level technology, which may be beneficial in creating rectangular shaped optical components by dicing lens surfaces in the desired aspect ratio. In some embodiments, the lens module 107 is manufactured using injection molding technology by creating molds that have non-symmetrical apertures. The components of the lens module 107 may be glass or plastic injection molded or machined (e.g., via wafer level technology).

The motor 112 is controlled by controller 113 and is configured to move the lens module or one or more optical components of the lens module 107. For example, the motor 112 moves one or more optical lenses along the optical axis to focus light onto the sensing plane of the image sensor 109. The imaging system may include multiple motors 112, for example, if multiple optical components should be moved separately or by different amounts. The motor 112 may include one or more actuator type mechanisms, one or more galvanometer type mechanisms, one or more mems type mechanisms, one or more motorized type mechanisms, one or more stepper motor type mechanisms, or some combination thereof. The motor 112 may also be referred to as a lens shift mechanism.

As stated above, the motor 111 rotates the reflector 105 around axis 115. To do this, the motor 111 may include one or more actuator type mechanisms, one or more galvanometer type mechanisms, one or more mems type mechanisms, one or more motorized type mechanisms, one or more stepper motor type mechanisms, or some combination thereof. In some embodiments, the motor 111 can move the reflector 105 in other directions. For example, the motor 111 can translationally and/or rotationally move the reflector 105 along the x axis, y axis, z-axis, or some combination thereof.

In some embodiments, motor 111 tilts the reflector 105 (e.g., by a few degrees in either direction) to compensate for motion (e.g., hand motion) while the image sensor 109 is capturing an image of a portion of the scene. For example, if a user tilts the mobile device 103 slightly downward, the motor may tilt the reflector 105 upward to compensate for the motion so that the image sensor 109 receives a same portion of the scene despite the tilting. In some embodiments, the imaging system 101 includes a sensor shift mechanism (e.g., another motor) to shift the image sensor 109 in one or more directions (e.g., in the xy-plane) to compensate for this motion. In some embodiments, the imaging system 101 includes motor 112 to shift the lens module 107 (or a component of it) in one or more directions (e.g., in the xy-plane) to compensate for this motion. If the imaging system 101 includes multiple motion compensating mechanisms, the controller 113 may coordinate the multiple mechanisms to work in conjunction to offset motion. For example, the motor 111 tilts the reflector 105 to compensate for motion in one direction and a sensor shift mechanism or a lens shift mechanism (e.g., 112) compensates for motion in another direction. In some embodiments, the reflector 105 rotates about multiple substantially perpendicular axes (e.g., the x-axis and z-axis) to compensate for motion (e.g., instead of a sensor or lens shift mechanism).

The motor 111 and shift mechanisms (e.g., 112) may also act as auto focusing mechanisms. For example, a lens shift mechanism shifts the lens module 107 (or a component of it) closer to or farther away from the image sensor 109 (e.g., along the z-axis) to achieve the desired focus. In another example, a sensor shift mechanism shifts the image sensor 109 closer to or farther away from the lens module 107 (e.g., along the z-axis) to achieve the desired focus.

The controller module 113 may constitute software (e.g., program code embodied on a machine-readable medium and executable by a processing system to have the processing system operate in a specific manner) and/or hardware to provide control signals (also referred to as adjustment signals) to the motor 111, motor 112, image sensor 109, or some combination thereof. Thus, the controller 113 may: (1) rotate the reflector 105 via motor 111 to direct light from different portions of the external environment towards the image sensor 109, (2) focus light on the image sensor 109 by adjusting optical components of the lens module 107 via motor 112, (3) synchronize the image sensor 109 with the reflector 105 to capture images of the different portions of the environment, or (4) some combination thereof. Additionally, the controller 113 may receive the captured images and combine them to form a lager continuous image of the external environment.

In some embodiments, the imaging system 101 includes one or more motion sensors (e.g., accelerometers, gyroscopes, etc.) to track motion of the imaging system relative to the external environment. The controller module 113 may receive motion data from the motion sensors. If the determined motion is above a threshold amount, the module 113 may provide instructions to the motor 111 and/or a sensor shift mechanism to compensate for the motion.

In some embodiments, the imaging system 101 is not contained in the mobile device 103. For example, the imaging system 101 is contained in a standalone device, such as a case for the mobile phone 103.

FIGS. 2A-2C illustrate the imaging system 101 capturing images of different portions of a view of an external environment, according to an embodiment. In the example of FIGS. 2A-2C, the external environment includes one or more objects within a field of view. In this example, for ease of discussion, the objects are a cube 211A, a sphere 211B, and a pyramid 211C that are vertically aligned. In FIG. 2A, the reflector 105 is tilted at a first rotational position (e.g., it forms angle θ₁ relative to the yz-plane) to direct light from the top portion of the external environment towards the image sensor 109. Thus, the image sensor 109 captures an image of the cube 211A. In FIG. 2B, the reflector is tilted at a second rotational position (e.g., it forms angle θ₂>θ₁ relative to the yz-plane) to direct light from the middle portion of the external environment toward the image sensor 109. Thus, the image sensor 109 captures an image of the sphere 211B. In FIG. 2C, the reflector is tilted at a third rotational position (e.g., it forms angle θ₃>θ₂ relative to the yz-plane) to direct light from the bottom portion of the external environment toward the image sensor 109. Thus, the image sensor 109 captures an image of the pyramid 211C. In some example embodiments, to capture a set of images, the reflector angles θ may range symmetrically around the 45 degree position (e.g., from 25-65 degrees) relative to the xy-plane.

FIG. 2D illustrates three image strips that were captured by the image sensor 109, according to an embodiment. Each image strip is an image of a different portion of the external environment due to each strip being captured while the reflector 105 was in a different rotational position. The image strips have high aspect ratios due to the high aspect ratio of the reflector 105, lens module 107, and image sensor 109. Image strip A is an image of the cube 211A and was captured by the image system 101 in FIG. 2A. Image strip B is an image of the sphere 211B and was captured by the image system 101 in FIG. 2B. Image strip C is an image of the pyramid 211C and was captured by the image system 101 in FIG. 2C.

The exposure time to capture each image strip may be limited by user motion (the user unintentionally moving the device 103 as they hold it) and by objects moving in the scene. Additionally, the total exposure time of the image strips may be limited by possible changes in the external environment between the capturing of image strips. The image strip exposure times and the total exposure time may be limited to predetermined threshold times or determined dynamically (e.g., based on an amount of movement of the mobile device 103).

FIG. 2E illustrates an image 201 of a view of the external environment, according to an embodiment. The image 201 is formed by combining (e.g., fusing or stitching) image strips A-C illustrated in FIG. 2D. The combined image 201 may be referred to as a composite image. The horizontal field of view of the combined image 201 may be based on the width (along the y-axis) of the window 102, reflector 105, lens module 107 (e.g., its aperture), and/or image sensor 109, and the vertical field of view of the combined image 201 may be based on the scanning range of the reflector 105. Typically, the vertical field of view is larger than the horizontal field of view.

Depending on the position of the reflector 105 when image strips are captured, the image strips may have some overlap with each other (e.g., 10-300 rows of pixels). Capturing image strips with overlap may help ensure that the image strips are not missing portions of a view of the environment (e.g., so that the entire view is captured) and may reduce the noise value of the combined image 201. Capturing image strips with overlap may also assist the combination process to ensure the image strips are combined properly. For example, the controller 113 uses overlapping portions to align the image strips during the combination process. In another example, if objects in the environment move between the capturing of image strips or if the mobile device 103 moves between the capturing of image strips, the control system 101 may use the overlapping portions to correct for artifacts caused by this movement.

### (i) Rotating the Reflector

The rotation of the reflector 105 may be discrete such that it rotates from an initial (e.g., maximal) angular position of the reflector 105 to the final (e.g., minimal) angular position with N stops, where N is the number of image strips which will form a combined image. N may be as small as two. N may depend on the desired exposure time of the combined image and/or the size of the smaller dimension of the image sensor 109 and the desired size or aspect ratio of the combined image. For example, if the image sensor has 24,000 pixels by 6,000 pixels and if the final combined image is to have a 4:3 aspect ratio, then the reflector 105 will have three discrete positions and the combined image will be 24,000 pixels by 18,000 pixels. The previous scanning example did not include any overlap in the image strips. If N is increased, then some areas in the scene will appear more than once in the image strips. For example, if the scanning is done using six discrete angular positions, then each point in the scene will appear in two image strips.

The imaging system 101 may be capable of capturing videos. In these cases, combined images may form frames of the video. If the video frame rate or preview frame rate is, for example, 25 FPS (frames per second) the total exposure time for each combined image is 40 milliseconds or less. In the case of a three discrete position scanning, each position may be exposed for 13.33 milliseconds. However, the reflector 105 needs time to change its position and to come to a stop, which means the exposure time may be around 10 milliseconds for each image strip.

For still image capture it is possible to interrupt an image preview displayed to the user when the user presses the capture button and allow longer exposure than the one limited by the image preview speed.

The above considerations considered a full field of view. If the imaging system 101 captures a narrower field of view, it may reduce the scanning range of the reflector 105. For example, if a user zooms in by a factor of three (i.e., 3× zoom), the imaging system 101 may not perform any scanning. Accordingly, the reflector 105 may be stationary. For example, if the image sensor 109 has 24,000 pixels by 6,000 pixels and the final image has a height of 6,000 pixels and an aspect ratio of 4:3, the reflector 105 may not rotate and the other dimension of the image may be 8,000 pixels (e.g., read out and cropped from the 24,000 pixel dimension of the image sensor 109).

In some embodiments, the rotation of the reflector 105 is continuous instead of discrete. In a continuous scanning mode, the reflector 105 continuously rotates at a speed that is slow enough that the captured images are not blurry, yet fast enough to finish scanning a desired field of view at desired frame rate (e.g., 40 milliseconds). In a continuous mode, the rotation rate of the reflector 105 may be dictated by a desired frame rate. For example, if a frame rate is 30 FPS (33 milliseconds between frames), the scene scanning takes around 25 milliseconds and then the reflector 105 is rotated back to its initial position. Other example values are possible, such as 30 milliseconds, depending on the how fast the reflector can be rotated back to its initial position. In embodiments where the reflector 105 is two sided, the reflector 105 may not need to be rotated back to its initial position.

In a continuous scanning mode, points in the external environment may appear on every line of pixels during a scan. The image sensor 109 may capture enough images so that a point is captured by each row of pixels for consecutive image strips. For example, if the image sensor 109 includes 6000 rows of pixels, it may capture 6000 images during a single scan. To do this, for example, an image sensor may, instead of integrating charge on one pixel for a certain number of milliseconds, integrate charge from changing pixels. If this change (scan) is synchronized with the reflector rotational speed, then the output can correspond to one point in space. An example implementation of this with an image sensor 109 is reading out just one pixel row, which can happen very quickly. So, for example, a sensor that does 30 FPS (frames per second) and has 6000 rows can perform 15000 FPS with reading out just one row. Alternative to capturing enough images so that a point is captured by each row of pixels, the image sensor 109 may capture a predetermined number of images during a scan that is less than the number of pixel rows.

### Adjustable Aperture Systems

As previously stated, imaging systems may include an adjustable aperture module that can adjust the shape or size of an aperture during operation of the imaging system. More specifically, an adjustable aperture module includes a deformable layer between two (e.g., rigid and substantially transparent) sheets. The deformable layer forms an aperture (e.g., it includes a substantially opaque material with a hole). The shape and size of the aperture can be changed by changing the distance between the sheets. For example, applying a force to reduce the sheet distance may deform the deformable layer such that the aperture size grows (or shrinks, depending on the material and design). Removing the force, or applying the force in the opposite direction, may cause the aperture size to shrink (or grow). This variable aperture size can be modeled as a function of the displacement caused by the changing the distance between the sheets. Among other advantages, an adjustable aperture module may enable an imaging system to quickly and reliably change the shape or size of the aperture during operation. Additionally, an adjustable aperture module may have a smooth aperture shape (e.g., circle or oval) across a wide range of aperture sizes and shapes.

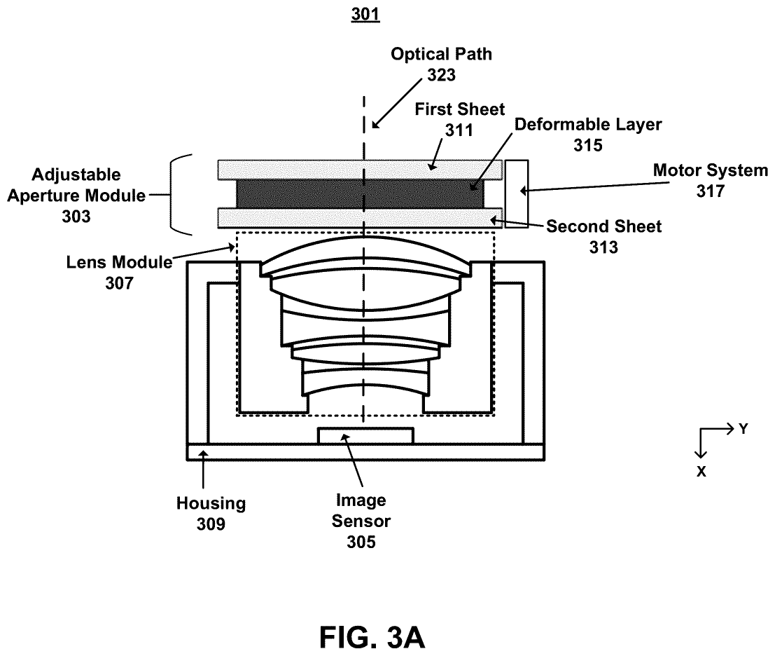

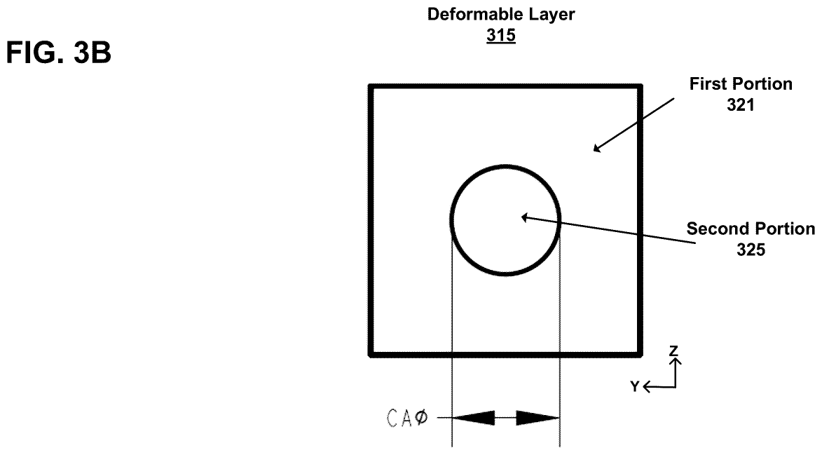

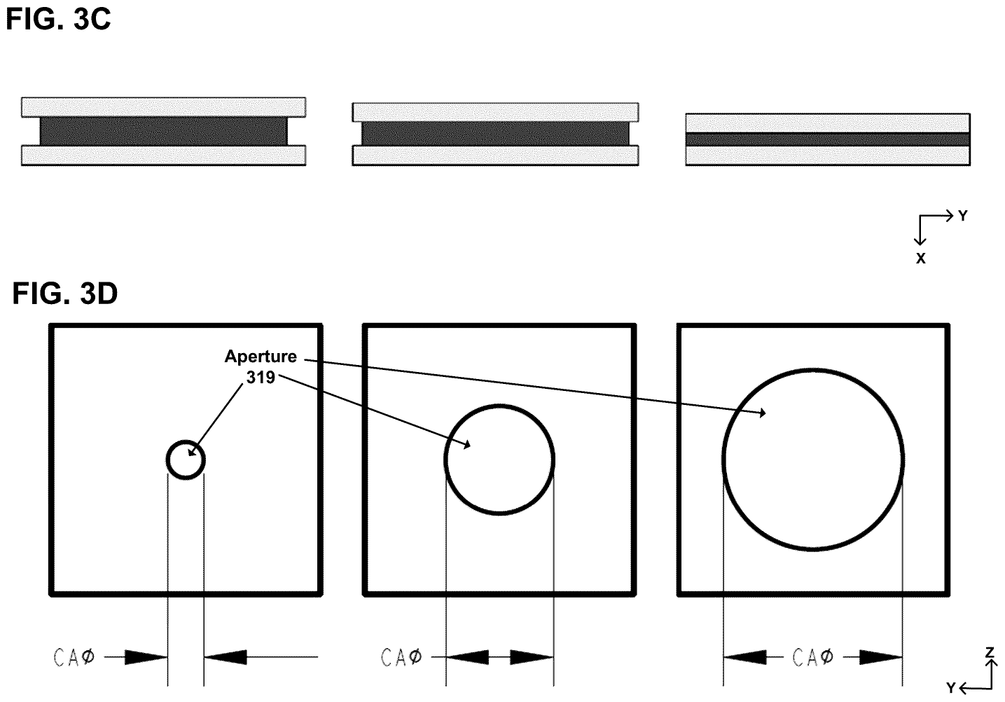

FIG. 3A is a diagram of an imaging system 301 with an adjustable aperture, according to one or more embodiments. The imaging system 301 includes a lens module 307 (enclosed by the dashed line), an image sensor 305, and an adjustable aperture module 303 (also “adjustable aperture system”). The adjustable aperture module 303 includes a first sheet 311, a second sheet 313, a deformable layer 315, a motor system 317, and a controller (not illustrated). The imaging system 301 may include different, additional, or fewer components than as illustrated.

The image sensor 305 is an imaging device that captures images of an external environment. The image sensor 305 may be, for example, a charge coupled device (CCD) sensor or a complementary metal-oxide semiconductor (CMOS) sensor.

The lens module 307 includes one or more optical components and is designed to form an image on the image sensor 305. The lens module 307 may spread, focus, redirect, and otherwise modify the light passing through it. The lens module 107 may be as simple as a single lens or it may include additional optical components, such as diffusers, phase screens, beam expanders, mirrors, and lenses (e.g., anamorphic lenses). The lens module 307 may be designed and manufactured to be non-circular or non-symmetric. The focal length of the lens module 307 may be different along the two dimensions perpendicular to the optical axis. The lens module 307 may be manufactured using wafer level technology. In some embodiments, the lens module 307 is manufactured using injection molding technology by creating molds that have non-symmetrical apertures or optical surfaces. The components of the lens module 307 may be glass or plastic injection molded or machined (e.g., via wafer level technology).

The optical pathway 323 illustrates that light propagates through an aperture formed by the adjustable aperture module 303, through the lens module 307, and to the image sensor 305. Other optical pathway arrangements are possible though. For example, the adjustable aperture module 303 may be placed between lenses of the lens module 307 or between the lens module 307 and the image sensor 305.

The first sheet 311 (also “first slide” or “first plate”) and the second sheet 313 (also “second slide” or “second plate”) are each substantially transparent (e.g., to one or more wavelengths detectable by the image sensor 305) and able to apply pressure to the deformable layer 315. A sheet may have a planar shape and may be rigid (e.g., rigid enough to apply an equal force to the deformable layer 315 across the surface area of the sheet). A sheet may be made of substantially transparent hard glass (e.g., BK-7), hard plastic, or some combination thereof.

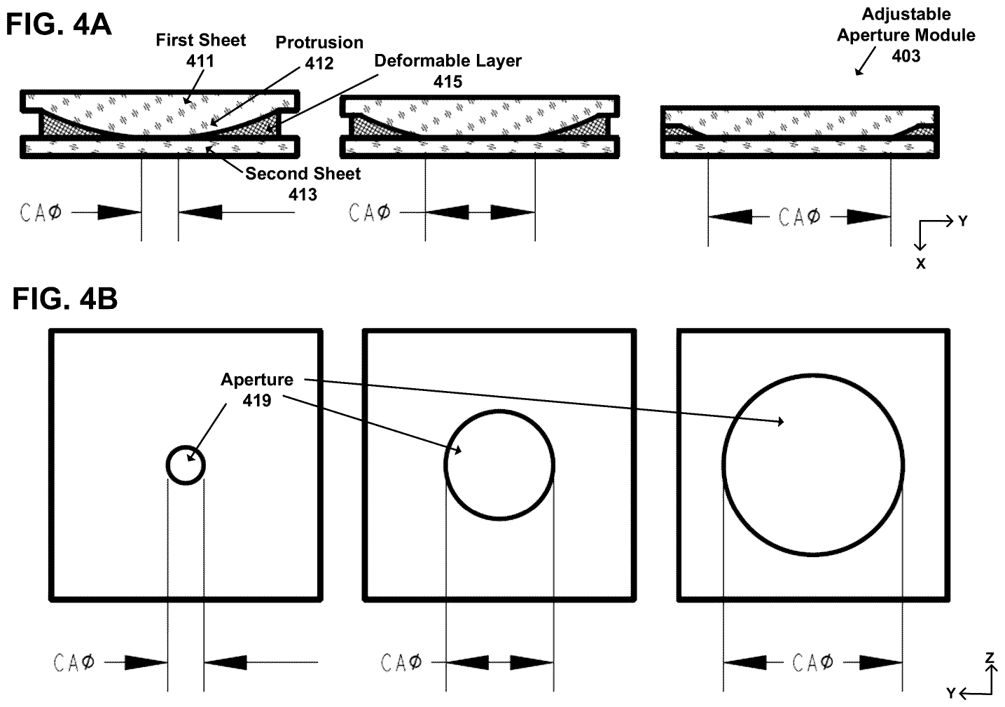

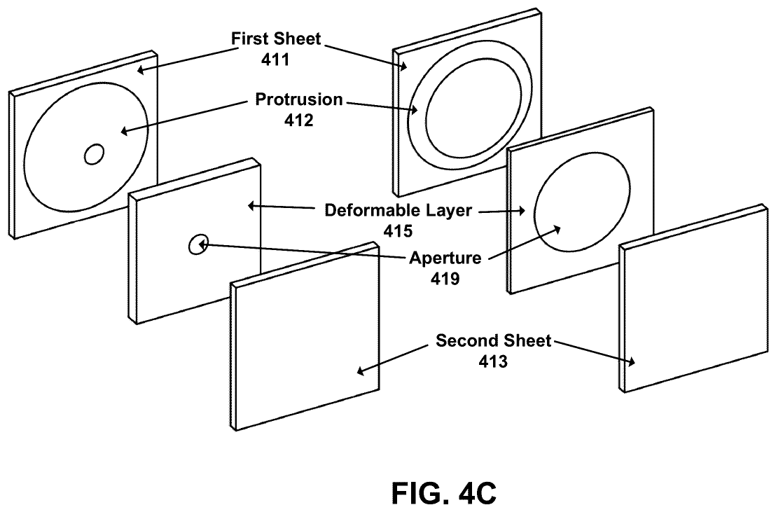

The deformable layer 315 is between the two sheets 311, 313. The deformable layer 315 forms an aperture (not illustrated in FIG. 3A). The deformable layer 315 includes material that can be deformed (e.g., compressed or stretched) when the sheet distances decrease (to change the size or shape of the aperture). The deformable layer 315 also has the ability to return to its previous shape or size when the sheet distance increases. A first portion of the deformable layer 315 is substantially opaque (e.g., to one or more wavelengths detectable by the image sensor 305) and a second portion of the deformable layer 315 is substantially transparent (e.g., to one or more wavelengths detectable by the image sensor 305). The second portion may be aligned with the optical path 323. FIG. 3B is a diagram of an example deformable layer 315 that includes a first portion 312 of substantially opaque material (a sheet of material in this example) and a second portion 325 that is substantially transparent. The first portion (e.g., 312) of the deformable layer 315 may be made of a solid material, a fluid, a gel, or some combination thereof. Example materials include silicone rubber, polyurethane gel, soft thermoplastic elastomer gel, hydrogels, water, mineral oil, or some combination thereof (incorporating dyes or other materials that absorb or reflect the desired wavelengths of light may be used). The second portion (e.g., 325) of the deformable layer 315 may be a hole in the material of the second portion or it may include a substantially transparent material such as a solid material, a film, a soft plastic, a fluid, a gel, or some combination thereof. Example materials include silicone rubber, polyurethane gel, soft thermoplastic elastomer gel, hydrogels, water, mineral oil, or some combination thereof. If the second portion (e.g., 325) is a hole, the hole may be circular, oval (e.g., elliptical), or some other shape (in the yz-plane). In some embodiments, the second portion is not a hole in the first portion material but is the result of the first portion material being pushed away to form the aperture (e.g., if the first portion material is a liquid or gel). The resulting aperture may be circular, oval (e.g., elliptical), or some other shape (in the yz-plane). The first portion material may be pushed away by, for example, a protrusion on one of the sheets (further described with respect to FIGS. 4A-4B).

By way of example, “substantially transparent” refers to an object or material that allows a majority of incident light (e.g., with wavelengths detectable by the image sensor) to propagate through it, such as allowing at least 60%, 70%, 80%, 90%, 95%, 99%, or 99.99% of the incident light to pass through. Also by way of example, “substantially opaque” refers to an object or material that prevents (e.g., blocks or absorbs) a majority of incident light (e.g., with wavelengths detectable by the image sensor) from propagating through it, such as preventing at least 60%, 70%, 80%, 90%, 95%, 99%, or 99.99% of the incident light from passing through.

Referring back to FIG. 3A, the motor system 317 is controlled by the controller (not illustrated in FIG. 3A). The motor system 317 adjusts the distance between the first sheet 311 and the second sheet 313. The motor system 317 may move one or both sheets to adjust the distance. If the adjustable aperture module 303 includes more than two sheets, the motor system 317 may move any combination of those sheets. To change the distance between the sheets, the motor system 317 may include (among other possible components) one or more actuators, one or more MEMS mechanisms, one or more motors (e.g., linear or rotational motors) or some combination thereof. The motor system 317 may include multiple motors (e.g., so that the distance between the sheets is uniform across the inner surface or within an error threshold. The error threshold may depend on the size of the imaging system and the desired accuracy. If the imaging system will be incorporated into a smartphone, the error threshold may be roughly less than 0.1 millimeters.

The motor system 317 may also include one or more position sensors. Signals from these one or more sensors may be used by the controller to determine the distance between the sheets (e.g., a position sensor at each side of the sheets). Thus, the controller can use signals from the position sensors 1149 to determine the deformable layer 315 is compressed evenly or at a known angle (e.g., to create non-symmetric apertures).

The controller (not illustrated in FIG. 3A), also “controller module,” may constitute software (e.g., program code embodied on a machine-readable medium and executable by a processing system to have the processing system operate in a specific manner) and/or hardware to provide control signals (also referred to as adjustment signals) to the motor system 317, the image sensor 305, or some combination thereof. Thus, the controller may transmit signals to: (1) adjust a distance between the two sheets to change a size or shape of the aperture (by controlling the motor system 317), (2) capture an image by the image sensor 305 (by controlling the image sensor 305), or some combination thereof.

The controller, through the signals transmitted, may determine the shape and size for the aperture and then adjust the distance between the sheets accordingly. For example, the controller receives a signal based on input from a user of the imaging system 301 (e.g., specifying an aperture shape or size) indicating an aperture setting. Additionally, or alternatively, the controller may determine the aperture shape or size based on signals from one or more sensors of the imaging system 301. For example, if a signal from the image sensor 305 indicates the environment has low ambident light, the controller may adjust the sheets to increase the aperture size.

The controller may be capable of performing additional functionalities. Furthermore, the controller may be part of other controllers or systems. For example, if the imaging system 101 includes an adjustable aperture module, the controller may be part of the controller module 113. In another example, the controller is part of the motor system 117.

Many illustrations of the adjustable aperture modules in the following figures omit the controller and the motor system for simplicity.

FIG. 3C is a diagram of the two sheets (and the deformable layer 315) with three different distances between them, according to one or more embodiments. FIG. 3D illustrates the resulting apertures 319 corresponding to the distances in FIG. 3C, according to one or more embodiments (note that “CAP” signifies the resulting aperture diameter). Generally, the aperture size increases with decreasing distance between the sheets. More specifically, when the sheets are far apart (left diagram of FIG. 3C), the resulting aperture is small (left diagram of FIG. 3D). When the sheets are moved closer together (middle diagram of FIG. 3C), the resulting aperture is increased (middle diagram of FIG. 3D). Similarly, when the sheets are close together (right diagram of FIG. 3C), the resulting aperture is large (right diagram of FIG. 3D).

Note that FIGS. 3C-3D are examples. In other embodiments, the aperture size may increase with increasing distance between the sheets.

In some embodiments, one (or more) of the sheets of an adjustable aperture module (e.g., 303) includes one or more protrusions on an inner surface. A protrusion is configured to press against the inner surface of the other sheet to displace the deformable layer, thus increasing or decreasing the size of aperture. As the distance between the sheets decreases, more of the protrusion presses against the inner surface of the other sheet, resulting in increased displacement of the deformable layer 315, resulting in a larger or smaller aperture.

FIG. 4A includes a cross sectional diagram of an adjustable aperture module 403 with a conformable protrusion 412, according to one or more embodiments. More specifically, FIG. 4A includes cross-sectional diagrams of the adjustable aperture module 403 at three different sheet distances. The adjustable aperture module 403 in FIG. 4A includes a first sheet 411 (e.g., 311) with protrusion 412 (however, the protrusion 412 may be on the second sheet in other embodiments), a second sheet 413 (e.g., 313), and a deformable layer 415 (e.g., 315). The motor system and controller are omitted from FIG. 4A for simplicity. The protrusion 412 may be aligned with an optical path of an imaging system (not illustrated), since the protrusion 412 pressing against the second sheet 413 forms the aperture.

FIG. 4B illustrates the resulting apertures 419 corresponding to the distances in FIG. 4A, according to one or more embodiments (note that “CAP” signifies the aperture diameter in both figures). In this example, the aperture size generally increases with decreasing distance between the sheets.

FIG. 4C includes diagrams of exploded views of the adjustable aperture module 403, according to one or more embodiments. The left exploded view corresponds to the two sheets being at larger distance apart (corresponding to the left diagrams of FIGS. 4A and 4B), and the right exploded view corresponds to the two sheets being at a smaller distance apart (corresponding to the right diagrams of FIGS. 4A and 4B).

At least a portion of a protrusion (e.g., 412) on a sheet (e.g., 411 or 413) is substantially transparent (e.g., to one or more wavelengths detectable by the image sensor 305). A protrusion may be made of a material such as a solid material, a film, a soft plastic, a fluid, a gel, or some combination thereof. Example materials include silicone rubber, polyurethane gel, soft thermoplastic elastomer gel, hydrogels, water, mineral oil, or some combination thereof.

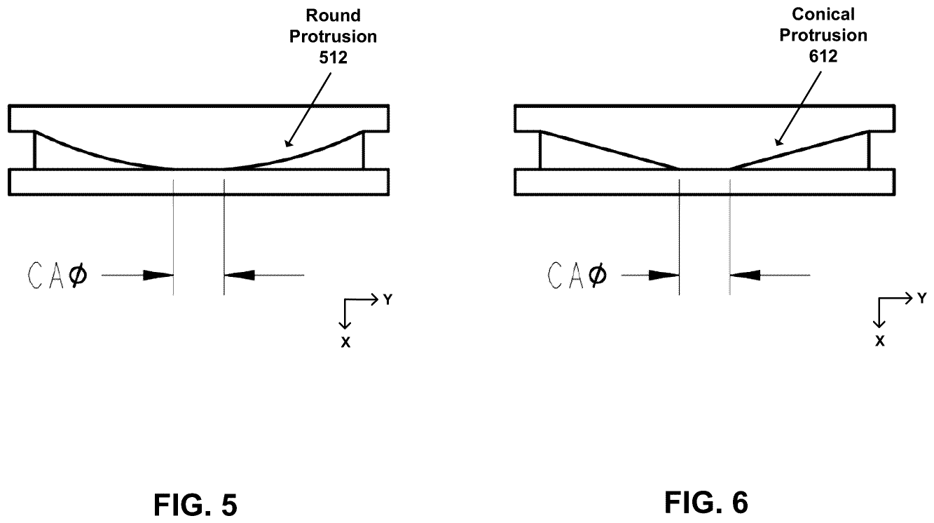

A protrusion (e.g., 412) on a sheet (e.g., 411 or 413) can have different shapes. For example, a protrusion has a rounded surface, which may form a round bump (the surface curvature may have a constant or nonconstant radius of curvature). Different curvature shapes of the rounded surface may affect the aperture shape and size for different sheet distances. In another example, a protrusion has straight edges, which may form a cone or conical shape. The gradient of the edges may affect the aperture shape and size for different sheet distances. FIG. 5 is a cross sectional diagram of an adjustable aperture module with a round protrusion 512, according to one or more embodiments (“CAP” signifies the aperture diameter for the current sheet distance and the motor system and controller are omitted for simplicity). FIG. 6 is a cross sectional diagram of an adjustable aperture module with a conical protrusion 512, according to one or more embodiments (“CAP” signifies the aperture diameter for the current sheet distance and the motor system and controller are omitted for simplicity).

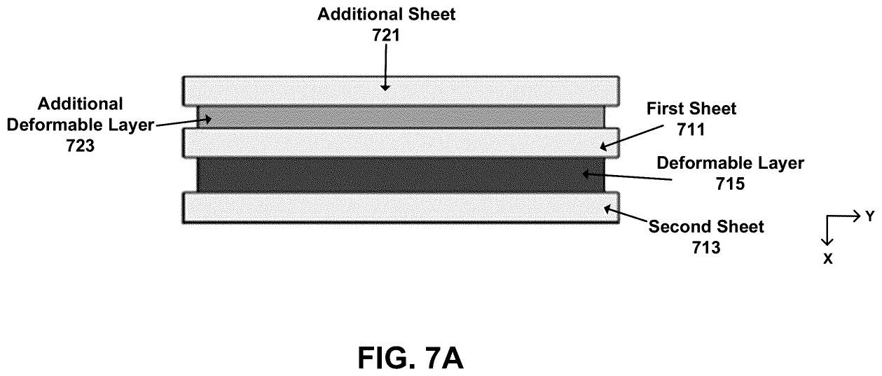

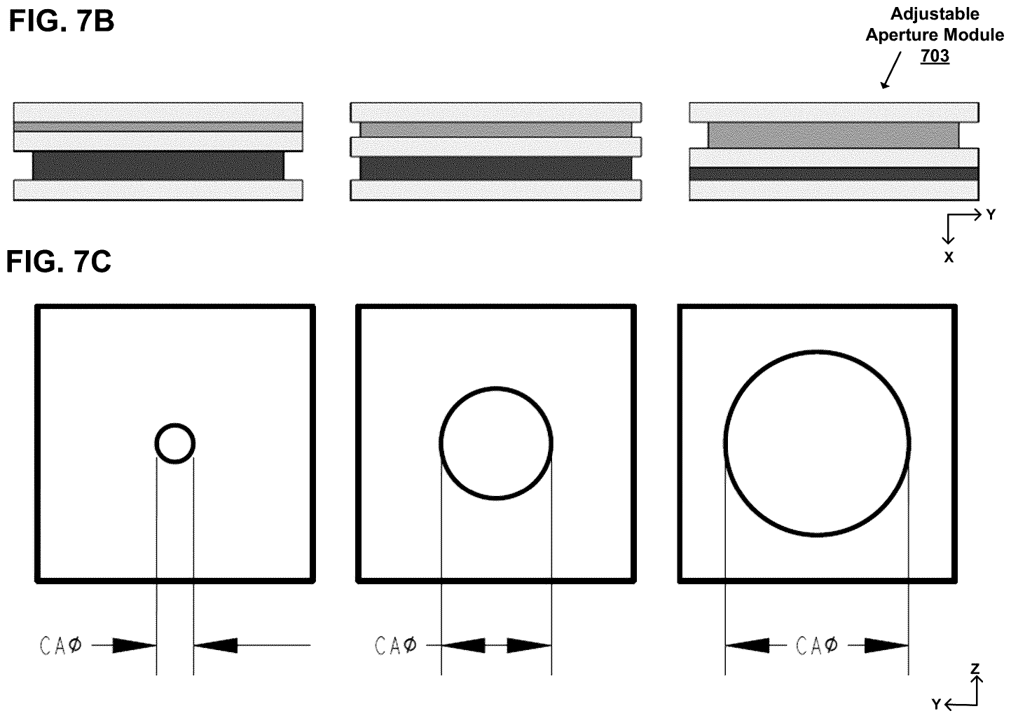

In some embodiments, an adjustable aperture module includes an additional sheet and an additional deformable layer, which forms a three-sheet adjustable aperture module. FIG. 7A is a diagram of an adjustable aperture module 703 with three sheets, according to one or more embodiments (motor system and controller omitted for simplicity). The adjustable aperture module 703 includes a first sheet 711 (e.g., 311), a second sheet 713 (e.g., 313), a deformable layer 715 (e.g., 315), an additional sheet 721 (also “additional slide” or “additional plate”), and an additional deformable layer 723.

The additional deformable layer 723 is placed between the additional sheet 721 and first sheet 711 (alternatively, the additional deformable layer 723 and the additional sheet 721 may be on the other side of the module 703). The additional sheet 721 may be along an optical path, aligned with the two sheets (711, 713), positioned on one of the sides of the two sheets (in other words, the additional sheet 721 is not between the two sheets), or some combination thereof.

The additional sheet 721 and the additional deformable layer 723 are substantially transparent (e.g., to one or more wavelengths detectable by the image sensor 305). The additional sheet 721 may be made of the same material and may have the same structure as sheets 711, 713 (which may have the same material and structure as sheets 311, 317). The additional deformable layer 723 can be deformed (e.g., compressed or stretched). The additional deformable layer 723 may be made of a material such as a solid material, a film, a soft plastic, a fluid, a gel, or some combination thereof. Example materials include silicone rubber, polyurethane gel, soft thermoplastic elastomer gel, hydrogels, water, mineral oil, or some combination thereof.

A motor system (not illustrated) may move the center sheet (i.e., 711) in order to change the aperture size or shape, and the exterior sheets (i.e., 721 and 713) may remain stationary. This has the benefit of the adjustable aperture module 703 maintaining a constant thickness along the optical path, regardless of the chosen aperture size or shape.

FIG. 7B is a diagram of the adjustable aperture module 703 with the center sheet at three different locations (said differently, the center sheet is at three different distances relative to the bottom sheet and the top sheet), according to one or more embodiments (the motor system and controller are omitted for simplicity). FIG. 7C illustrates the resulting apertures corresponding to the distances in FIG. 7B, according to one or more embodiments (“CAP” signifies the aperture diameter, and the motor system and controller are omitted for simplicity). Generally, the aperture size increases with decreasing distance between the center sheet and the bottom sheet (since the deformable layer 715 that forms the aperture is between them).

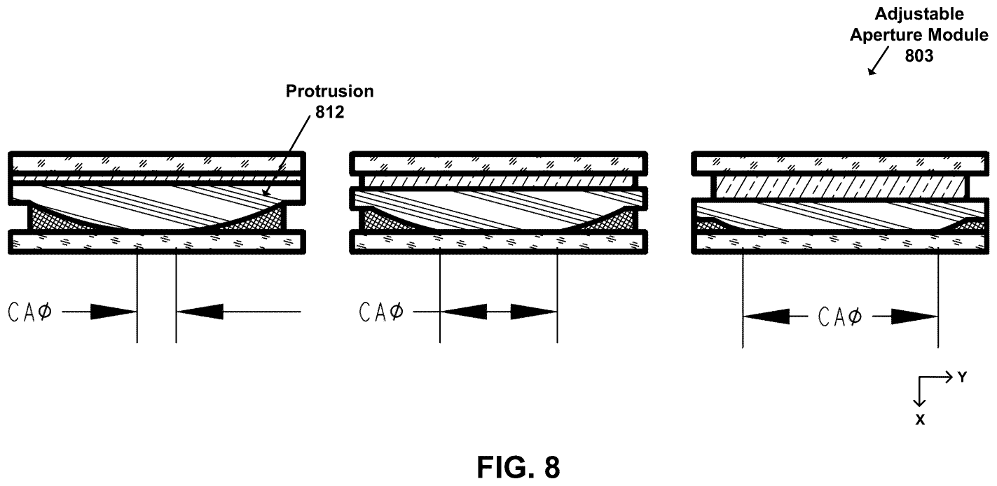

A three-sheet adjustable aperture module may include a protrusion (as described with respect to FIGS. 4A-C). FIG. 8 includes cross sectional diagrams of an adjustable aperture module 803 with the center sheet at three different locations, according to one or more embodiments (the motor system and controller are omitted for simplicity). The center sheet includes a protrusion 812 (e.g., 412) which is used to adjust the aperture size or shape (as described with respect to FIGS. 4A-C). The resulting apertures are similar to those in FIG. 7C.

Referring back to FIGS. 3A-3D, the deformable layer 315 is illustrated as a square sheet with much of its material covering the inner surfaces of the first and second sheets.

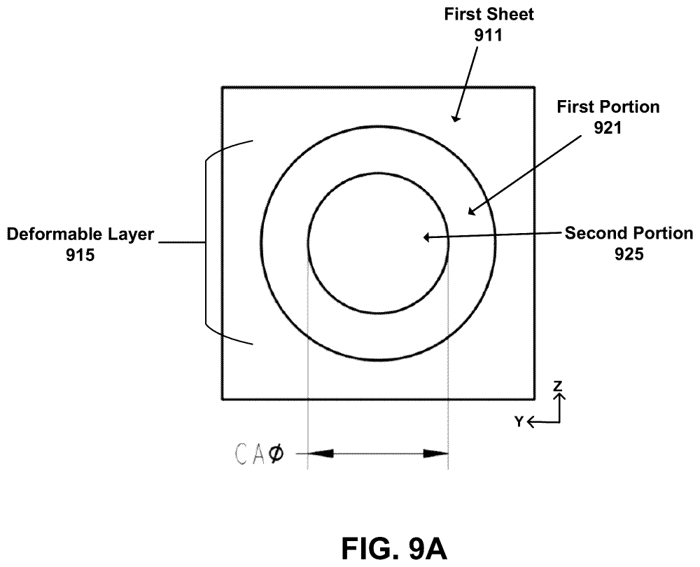

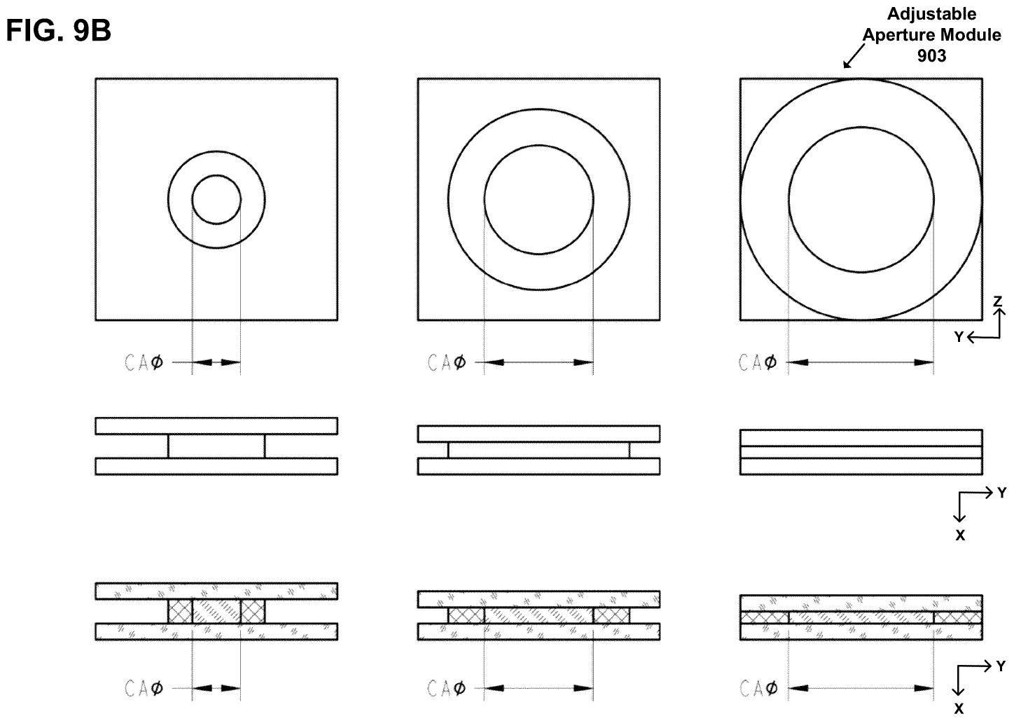

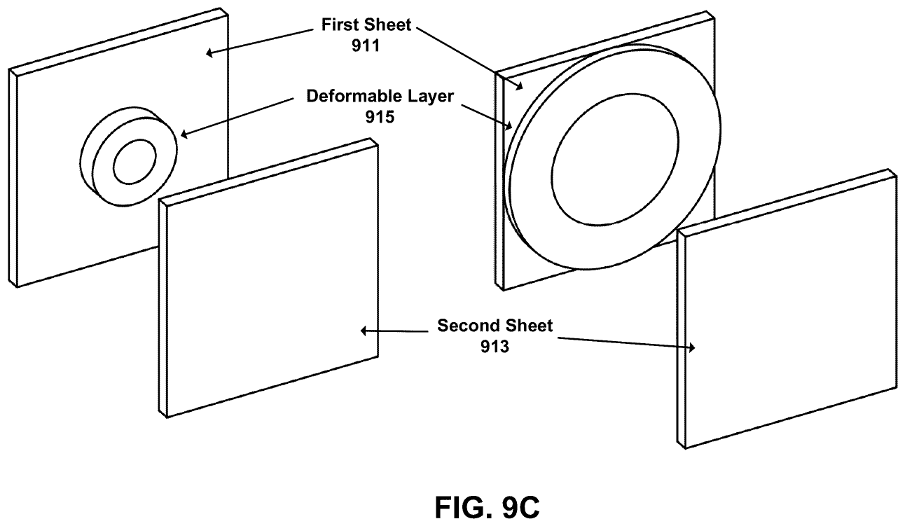

However, this is not required. In other embodiments, a deformable layer may reside on a smaller portion of the inner sheet surfaces, the deformable layer may have a different shape, or some combination thereof. FIG. 9A illustrates an example of this.

FIG. 9A is a diagram of a deformable layer 915 on a first sheet 911 (e.g., 311) of an adjustable aperture module, according to one or more embodiments. “CAP” signifies the resulting aperture diameter formed by the deformable layer 915. The deformable layer 915 has a circular shape in the yz-plane (however other shapes are possible, such as an oval) and includes a first portion 921 and a second portion 925 (similar to the first and second portions described with respect to FIGS. 3A-3B). The second portion 925 may be made of a material that is not compressible or is less compressible (e.g., silicon oil), so that it extends or spreads along the y and z axes when the sheet distance decreases.

FIG. 9B includes diagrams of an adjustable aperture module 903 (with deformable layer 915) for three different sheet distances, according to one or more embodiments (the motor system and controller are omitted for simplicity). Each column of diagrams in FIG. 9B corresponds to a different sheet distance (“CAP” signifies the resulting aperture diameter). The bottom row of diagrams are cross sectional views of the adjustable aperture module 903 for each distance. The middle row of diagrams are top views of the adjustable aperture module 903 for each distance. The top row of diagrams illustrates the resulting apertures for each distance. In this example, the aperture size generally increases with decreasing sheet distance. As illustrated, at the smaller distances, the deformable layer 915 expands in the y-direction (and in the z-direction) and the deformable layer 915 contracts along the x-direction (due to the sheets being closer together).

FIG. 9C includes diagrams of exploded views of the adjustable aperture module 903, according to one or more embodiments. The left exploded view corresponds to the first sheet 911 and the second sheet 913 being at a larger distance apart (corresponding to the left column of FIG. 9B), and the right exploded view corresponds to the two sheets being at a smaller distance apart (corresponding to the right column of FIG. 9B).

Although FIGS. 9B and 9C illustrate the adjustable aperture module 903 as only including two sheets (911, 913), the adjustable aperture module 903 may be modified to be a three-sheet adjustable module (as described with reference to FIGS. 7A-C).

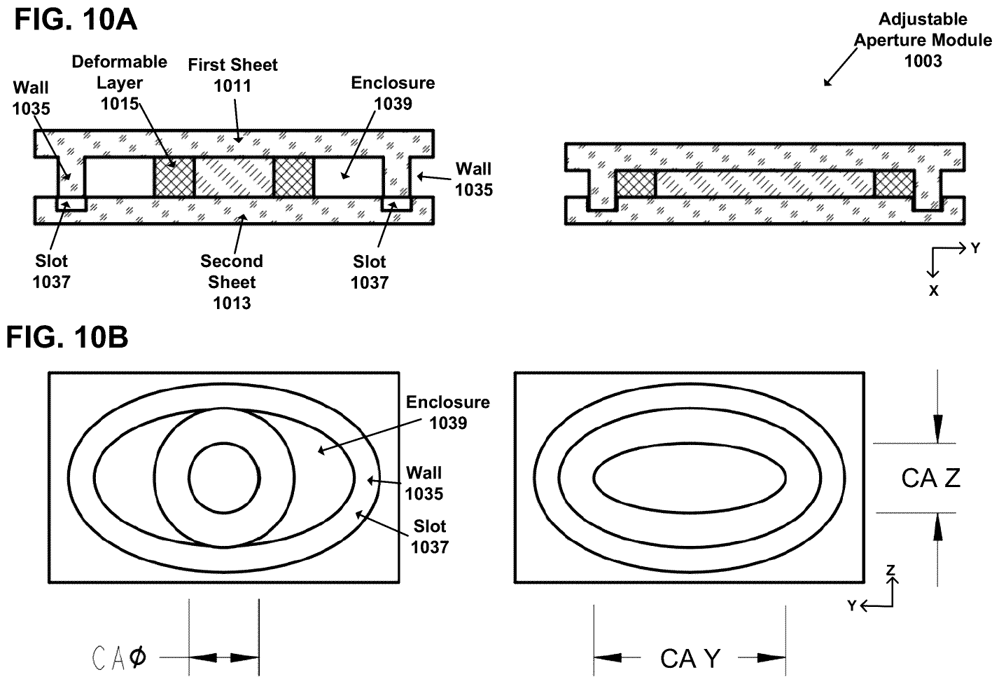

In some embodiments, sheets of an adjustable aperture module include walls and slots configured to receive the walls. FIGS. 10A-10D illustrate an example adjustable aperture module 1003 with a wall 1035 and corresponding slot 1037 (the motor system and controller are omitted for simplicity). FIGS. 10A includes cross sectional diagrams of an adjustable aperture module 1003 for two different sheet distances, according to one or more embodiments. FIG. 10B illustrate the resulting apertures of the adjustable aperture module 1003 for the distances of FIG. 10A, according to one or more distances (“CAΦ” signifies the aperture diameter, “CA Y” signifies the largest aperture width (along the y-axis), and “CA Z” signifies the largest aperture height (along the z-axis)). FIGS. 10C and 10D include diagrams of exploded views of the adjustable aperture module 1003, according to one or more embodiments. The left exploded view (of both figures) corresponds to the two sheets being at a larger distance apart (corresponding to the left diagrams of FIGS. 10A and 10B), and the right exploded view (of both figures) corresponds to the two sheets being at a smaller distance apart (corresponding to the right diagrams of FIGS. 10A and 10B).

The first sheet 1011 includes a wall 1035 and the second sheet 1013 includes a slot 1037 that can receive the wall 1035 (so that the wall 1035 doesn't prohibit smaller sheet distances). As illustrated in FIG. 10A, at the closer distance (right diagram), the wall 1035 is inside the corresponding slot 1037. Furthermore, at the closer distance, the deformable layer 1015 has expanded in the y-direction to fill the enclosure 1039 and the deformable layer 1015 has contracted along the x-direction (due to the sheets being closer together). Among other advantages, the wall can guide the expansion and contraction of the deformable layer 1015 (as the two sheets change distances) to change the size or shape of the aperture. In the example of FIGS. 10A-10D, when the sheets are farther apart, the deformable layer 1015 forms a circular aperture, but when the sheets are closer together, the wall 1035 guides the expansion (along the y and z axes) so the deformable layer 1015 forms an oval aperture. More specifically, the wall 1035 restricts expansion along the z-axis, resulting in greater expansion along the y-axis.

In the example of FIGS. 10A-10D, the wall 1035 and slot 1037 have an oval shape (in the yz plane). Thus, when the sheets are brought together, they form a fully enclosed enclosure 1039 for the deformable layer 1015. However, this is not required. In other examples, a sheet may include multiple wall segments and corresponding slots. Furthermore, other wall and slot shapes are possible, such as circular and elliptical shapes.

Although FIGS. 10A-10D illustrate the adjustable aperture module 1003 as only including two sheets (1011, 1013), the adjustable aperture module 1003 may be modified to be a three-sheet adjustable module (as described with reference to FIGS. 7A-C).

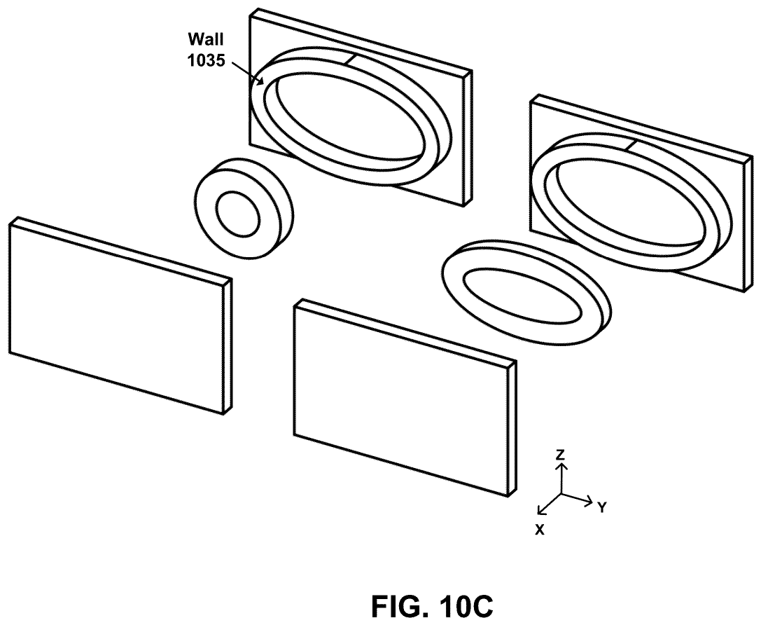

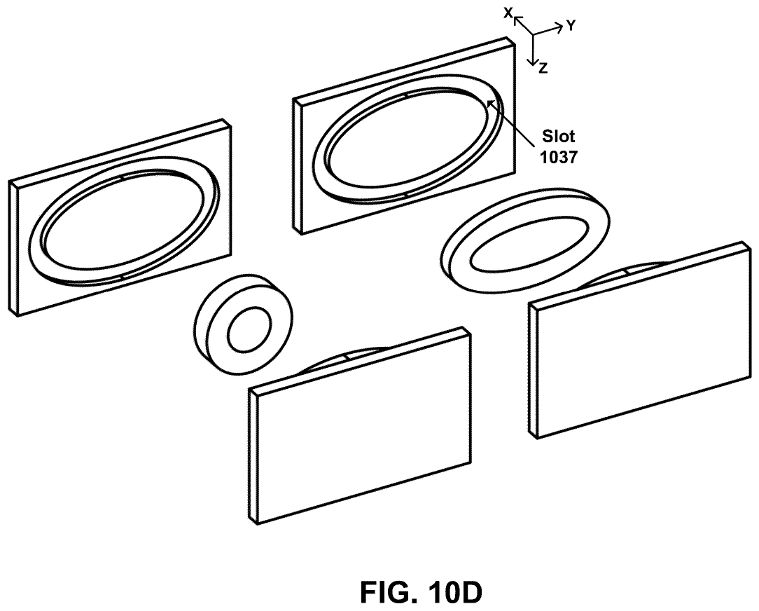

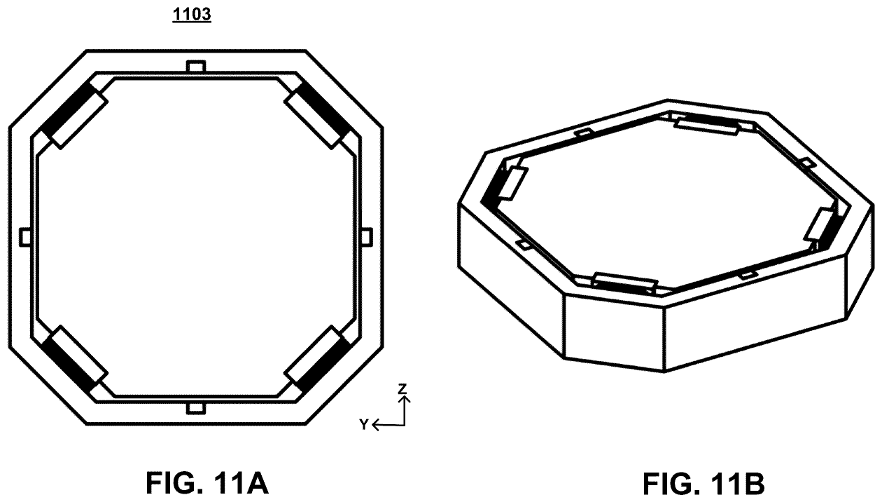

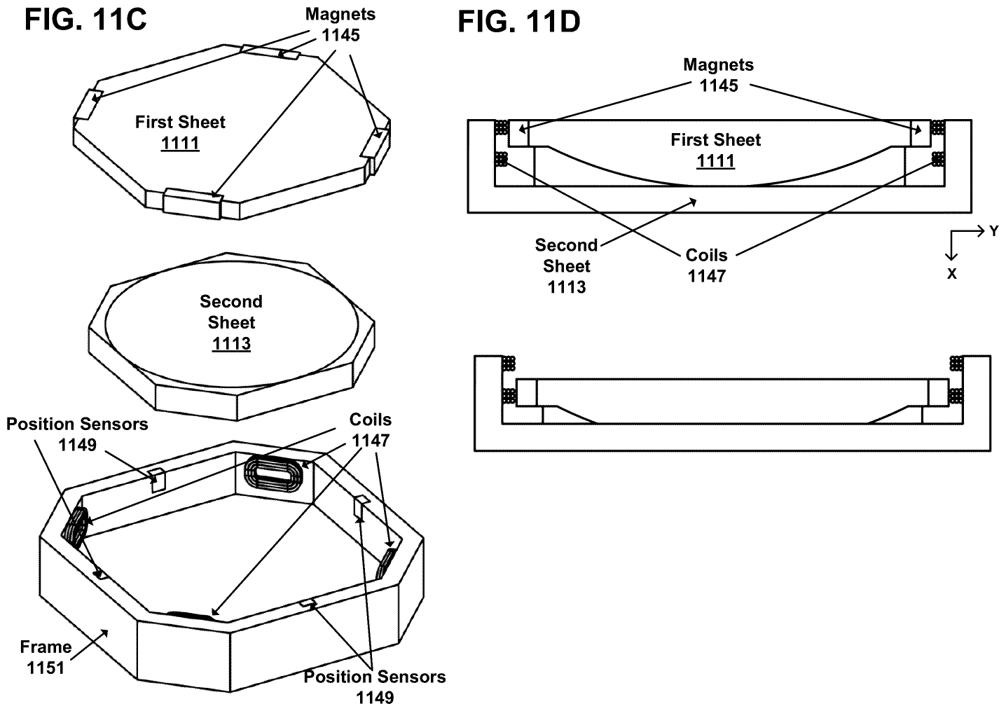

FIGS. 11A-11D are diagrams of various views of an adjustable aperture module 1103, according to one or more embodiments. For example, FIG. 11B is a diagram of a perspective view of the adjustable aperture module 1103, FIG. 11C is a diagram of an exploded view of the adjustable aperture module 1103, and FIG. 11D includes cross sectional diagrams of the adjustable aperture module 1103 for two different sheet distances (the bottom diagram illustrates a smaller sheet distance than the top diagram).

Similar to previous adjustable aperture modules, the adjustable aperture module 1103 includes a first sheet 1111, a second sheet 1113, a deformable layer (not labeled), and a motor system (the controller is omitted for simplicity). The motor system includes a frame 1151, position sensors 1149 (e.g., MEMS mechanism such as hall effect sensors or magnetic encoders), and a set of voice coil motors, which includes coils 1147 and magnets 1145 (other types of motors may be used, such as piezoelectric actuators, stepper motors, and other types of micro actuators).

The frame 1151 surrounds outer edges of the first sheet 111 and the second sheet 1113. The coils 1147 are mounted to the inner sides of the frame 1151. The magnets 1145 are mounted to the first sheet 1111. Current through the coils 1147 results in forces on the magnets 1145 that can push the two slides together or apart.

In this embodiment, the position sensors 1149 are mounted to inner sides of the frame 1151. The position sensors 1149 may be used (e.g., by a controller) to determine appropriate force is applied to each corner or side of the first sheet 1111. Thus, a controller can use signals from the position sensors 1149 to determine the deformable layer is compressed evenly or at a known angle (e.g., to create non-symmetric apertures).

Although FIGS. 11A-10D illustrate the adjustable aperture module 1103 as only including two sheets (1111, 1113), the adjustable aperture module 1103 may be modified to be a three-sheet adjustable module (as described with reference to FIGS. 7A-C). Furthermore, although the first sheet 1111 includes a protrusion, this is not required. Additionally, the deformable layer (not labeled) can have different shapes, as previously described and illustrated (e.g., see FIGS. 3A-3D and 9A-9C).

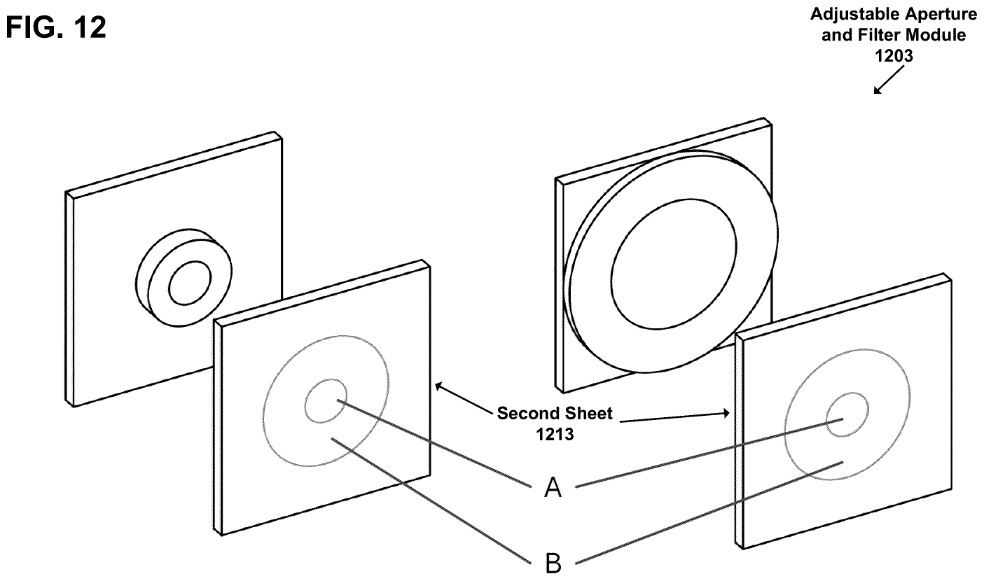

In some embodiments, an adjustable aperture module includes an (e.g., adjustable) optical filter. These embodiments may be referred to as an “adjustable aperture and filter module.” In an example embodiment, a filter is coated on one of the sheets. FIG. 12 is an example of an adjustable aperture and filter module 1203 with a filter on a portion of the second sheet 1213, according to one or more embodiments (the motor system and controller are omitted for simplicity). Section A is coated with a filter that filters infrared (IR) wavelengths. Section B does not include the IR coating. When the aperture is small (e.g., the sheet distance is large), few or no IR light passes through the aperture due to the IR coating (see left exploded view diagram). However, when the aperture size is large (e.g., due to the sheet distance being small), IR light passes through the aperture due to the IR coating only being on section A (see right exploded view diagram). This may allow for greater light gathering ability in low-light scenarios, typically indoors, where there is little or no IR light from the sun, but blocks it when sunlight is present in bright light scenarios (since the aperture is typically small in bright light scenarios and large in low light scenarios).

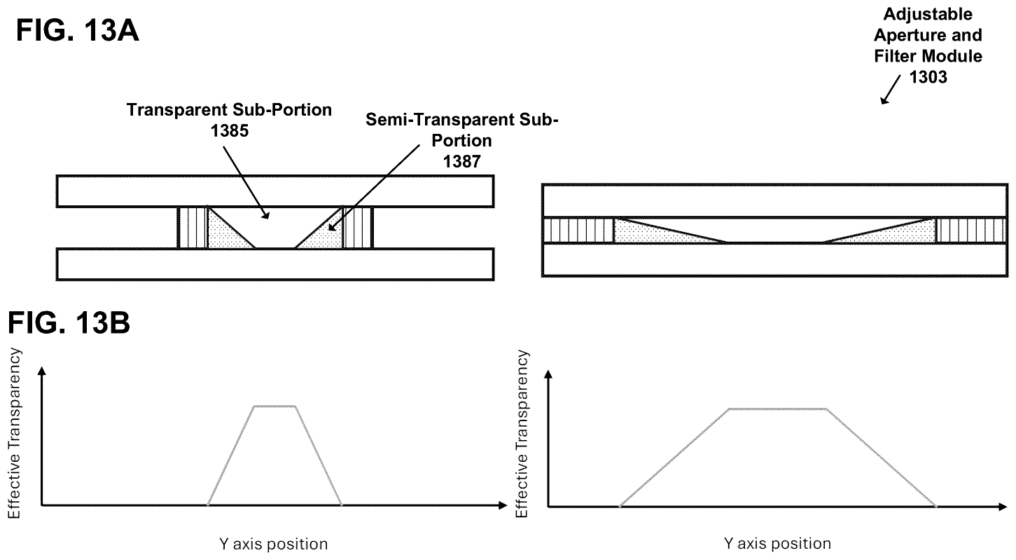

In some embodiments, the filter of an adjustable aperture and filter module can act as an adjustable apodization filter. FIGS. 13A-13B illustrate an example embodiment of this. FIG. 13A includes cross sectional diagrams of an adjustable aperture and filter module 1303, where the second portion of the deformable layer includes a substantially transparent sub-portion 1385 and a semi-transparent sub-portion 1387, according to one or more embodiments (the motor system and controller are omitted for simplicity). The semi-transparent sub-portion 1387 may be a liquid that includes carbon black, graphite, IR-absorbing dyes, or some combination thereof to absorb or block desired wavelengths. FIG. 13B includes transparency plots for the corresponding diagrams in FIG. 13A. Thus, when the sheet distance is large (left diagram and plot), the semi-transparent sub-portion 1387 is smaller (along the y-axis), resulting in a steep gradient in effective transparency while moving along the y-axis. However, when the sheet distance is small (right diagram and plot), the semi-transparent sub-portion 1387 is spread out (along the y-axis), resulting in a shallow gradient in effective transparency while moving along the y-axis.

In some embodiments, a deformable layer includes a (e.g., adjustable) filter and is not configured to form an aperture. These embodiments may be referred to as an “adjustable filter module.” Adjustable filter modules include sheets and a deformable layer, similar to adjustable aperture modules.

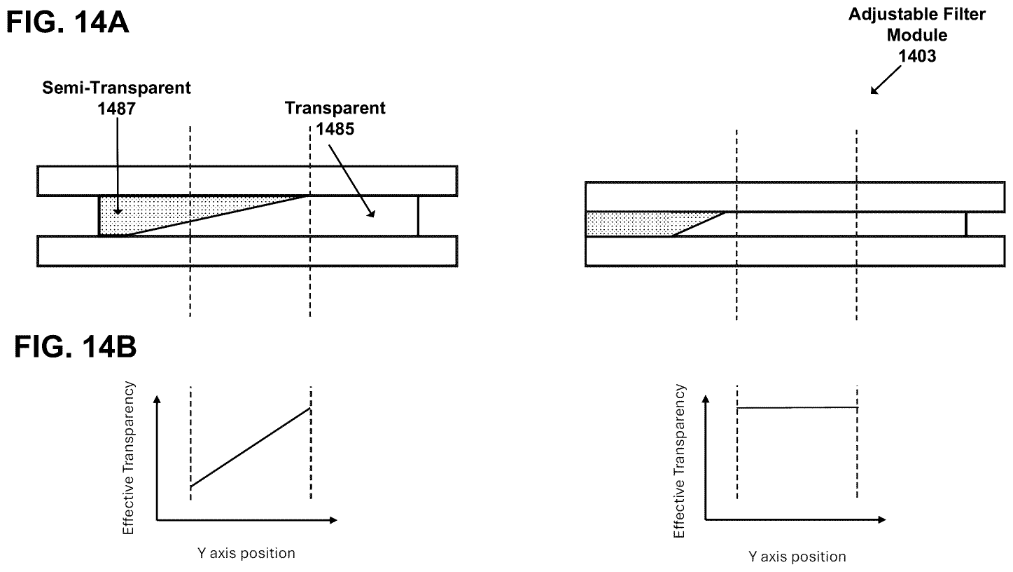

In some embodiments, the deformable layer of an adjustable filter module can act as an adjustable gradient filter. FIGS. 14A-14B illustrate an example embodiment of this. FIG. 14A includes cross sectional diagrams of an adjustable filter module 1403, with the deformable layer including a substantially transparent portion 1485 and a semi-transparent portion 1487, according to one or more embodiments (the motor system and controller are omitted for simplicity). The semi-transparent sub-portion 1487 may be, for example, a liquid that includes carbon black, graphite, IR-absorbing dyes, or some combination thereof to absorb or block desired wavelengths. FIG. 14B includes transparency plots for the corresponding diagrams in FIG. 14A. Thus, when the sheet distance is large (left diagram and plot), the semi-transparent sub-portion 1487 results in a gradient in effective transparency while moving along the y-axis (between the vertical dashed lines). However, when the sheet distance is small (right diagram and plot), the semi-transparent sub-portion 1487 moved to the left, resulting in a constant effective transparency while moving along the y-axis (between the vertical dashed lines).

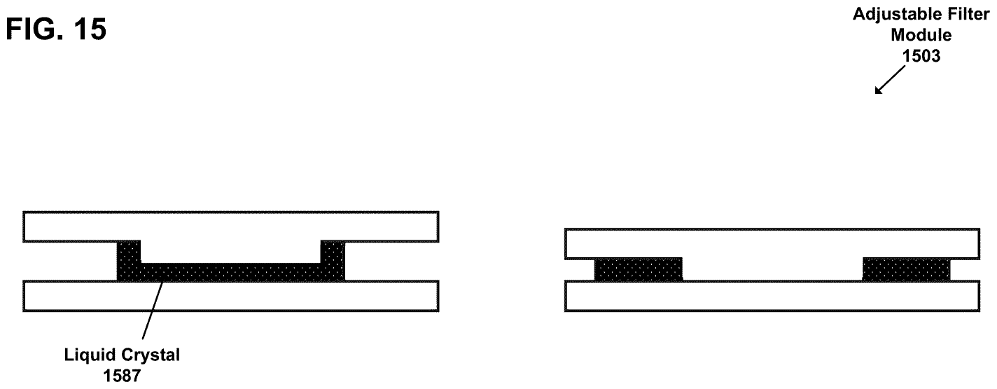

In some embodiments, the deformable layer of an adjustable filter module can act as an adjustable polarization filter with liquid crystal. FIGS. 15 illustrates an example embodiment of this. FIG. 15 includes cross sectional diagrams of an adjustable filter module 1503, with the deformable layer including a portion of liquid crystal 1587, according to one or more embodiments (the motor system and controller are omitted for simplicity). The polarity of the liquid crystal 1587 will align with an external electric field, thus filtering out incident light that has the non-aligned polarity. The external electric field can be applied with many types of devices (e.g. parallel plate capacitor or segmented electrodes). When the sheet distance is large (left diagram), the liquid crystal 1587 filters light. However, when the sheet distance is small (right diagram), the liquid crystal 1587 is pushed to the edges, resulting in little or no filtering in the middle portion.

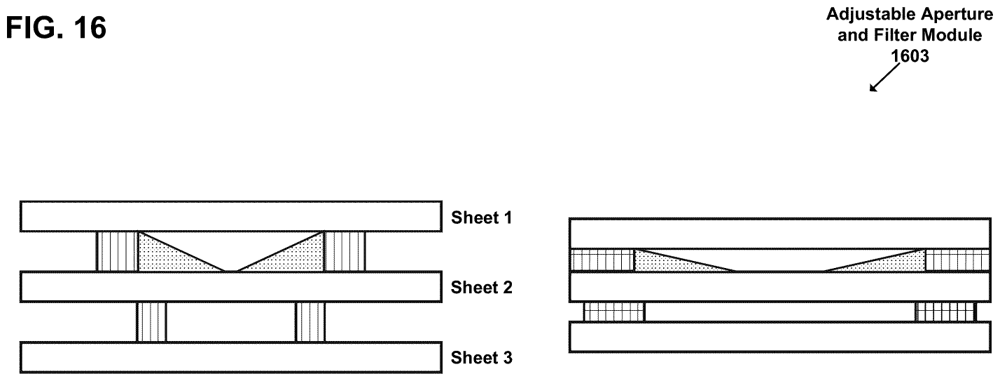

In some embodiments, an adjustable aperture and filter module includes a module with a filter (e.g., 1303, 1403, 1503) combined with an adjustable aperture module (e.g., 403, 903, 1003). FIG. 16 illustrates an example embodiment of this. FIG. 16 includes cross sectional diagrams of an adjustable aperture and filter module 1603, according to one or more embodiments (the motor system and controller are omitted for simplicity). The adjustable aperture and filter module 1603 includes three sheets (labeled 1, 2, 3). The deformable layer between sheets 1 and 2 includes the adjustable apodization filter described with respect to FIGS. 13A-13B. The deformable layer between sheets 2 and 3 includes the deformable layer 915 described with respect to FIGS. 9A-C. To adjust the filter between sheets 1 and 2 and to adjust an aperture between sheets 2 and 3, motors of a motor system may be coupled to sheets 1 and 3 and configured to move them (e.g., adjust the sheet distances), while sheet 2 may be configured to remain stationary. The motors (e.g., actuators) may move sheets 1 and 3 independently or in synchronization.

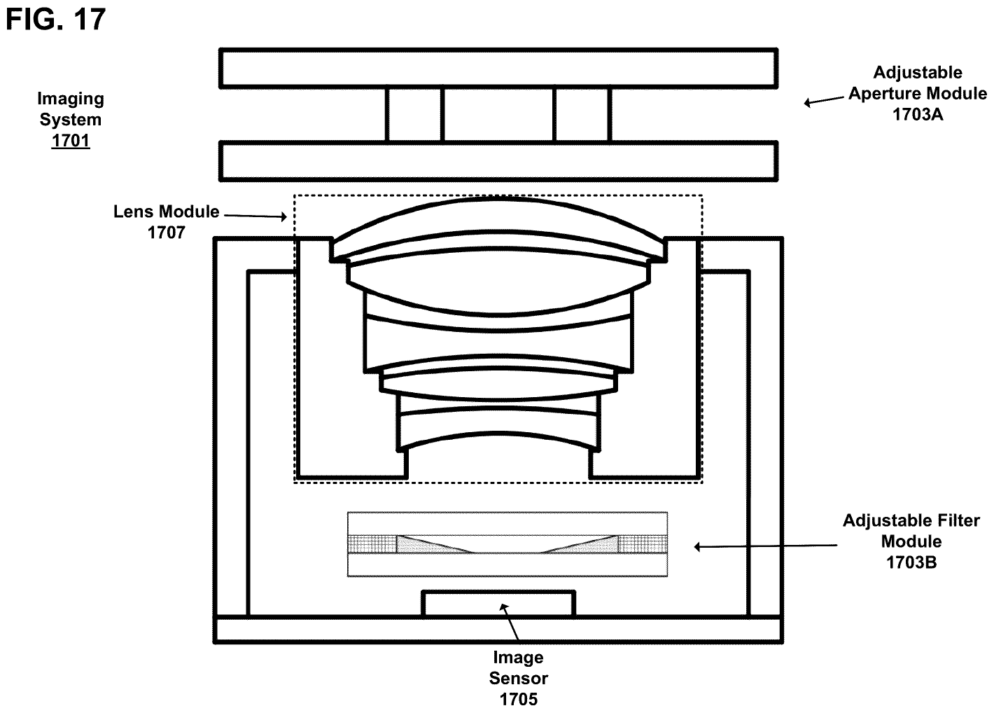

In some embodiments, a module with a filter (e.g., 1303, 1403, 1503) may be a physically separate component from an adjustable aperture module (e.g., 403, 903, 1003). FIG. 17 illustrates an example embodiment of this. FIG. 17 includes cross sectional diagrams of an imaging system 1701, according to one or more embodiments (the motor system and controller are omitted for simplicity). The imaging system 1701 includes an adjustable aperture module 1703A (e.g., 403, 903, 1003) upstream of the lens module 1707 (similar to FIG. 3A) and a module with a filter (e.g., 1303, 1403, 1503) between the lens module 1707 and the image sensor 1705.

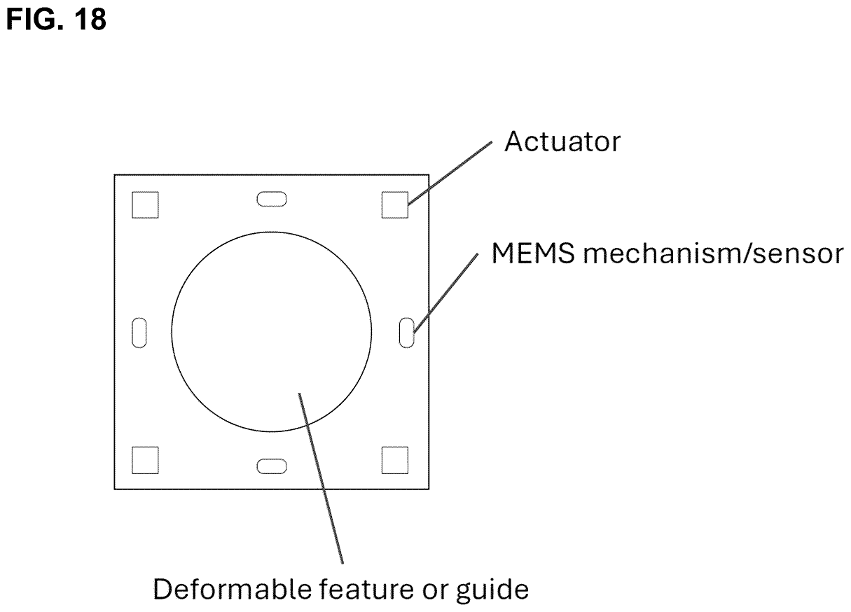

FIG. 18 is a diagram of an example sheet (of an adjustable aperture module) that includes integrated actuators (e.g., piezoelectric actuators), integrated MEMS mechanisms or sensors, and a deformable feature or guide (e.g., a protrusion), according to one or more embodiments.

FIG. 19 is an array of sheets (sheets from FIG. 18) configured for wafer manufacturing, according to one or more embodiments.

### Additional Example Adjustable Aperture Systems

The below paragraphs provide additional descriptions of imaging systems with aperture systems.

Some embodiments relate to an imaging system (e.g., 301) that includes: an image sensor (e.g., 305); two sheets along an optical path (e.g., 323) of the imaging system (e.g., 311 and 313, 711 and 713, 911, and 913, 1011 and 1013, 1111 and 1113), the two sheets being substantially transparent; and a deformable layer (e.g., 315, 715, 915, 1015) between the two sheets, the deformable layer forming an aperture that, for example, limits light incident on the image sensor (e.g., 319 and FIGS. 3D, 4B, 4C, 5-6, 7C, 8, 9B, 10B); and a motor (e.g., a motor of motor system 317) coupled to at least one of the sheets, the motor configured to adjust a distance between the two sheets, where the size of the aperture is based on the distance between the two sheets. The imaging system may include a controller (e.g., described with respect to FIG. 3A) configured to control the image sensor and the motor. The two sheets, deformable layer, motor, and controller may be part of an adjustable aperture module. Example adjustable aperture modules include 303, 403, 703, 803, 903, 1003, 1103.

In some aspects, the imaging system further includes: an additional sheet (e.g., 721) along the optical path of the imaging system; and an additional deformable layer (e.g., 723) between the additional sheet and a first sheet of the two sheets. In some aspects, the additional sheet and the additional deformable layer are substantially transparent. In some aspects, to adjust the distance between the two sheets, the motor is configured to move the first sheet along the optical path and between the additional sheet and a second sheet of the two sheets (e.g., see FIG. 7B). In some aspects, to adjust the distance between the two sheets, the motor is not configured to move the additional sheet or the second sheet (e.g., see FIG. 7B). For example, the motor is not configured to send a control signal to the additional sheet or the second sheet. In some aspects, a combined length of the two sheets, the deformable layer, the additional sheet, and the additional deformable layer remains constant (e.g., even during operation of the imaging system, such as when the first sheet is moved) (e.g., see FIG. 7B). The constant length may be subject to practical engineering considerations, such as changing length due to temperature changes or movement of the imaging system. Thus, the combined length may remain constant within an error threshold (e.g., 0.1 millimeters). The error threshold may depend on the size of the imaging system and the desired accuracy.

In some aspects, a first portion of the deformable layer is substantially opaque and a second portion of the deformable layer is substantially transparent (see e.g., FIG. 3B).

In some aspects, the deformable layer includes: a first material that is substantially opaque and that includes a hole which forms the aperture. In some aspects, the deformable layer further includes: a second material that is substantially transparent and in the hole of the first material. See e.g., FIG. 3B and related description for more information.

In some aspects, a first sheet of the two sheets includes a protrusion (e.g., 412, 512, 612, 812) on a surface that faces a second sheet of the two sheets. In some aspects, the protrusion is configured to press against the second sheet. In some aspects, wherein the protrusion has a conical shape (e.g., 612). In some aspects, the aperture is formed by the protrusion pressing against the second sheet and displacing the deformable layer (e.g., see FIGS. 4A-6, and 8 and related descriptions).

In some aspects, the aperture is configured to increase in size as the distance between the two sheets decreases (e.g., see FIGS. 3C-4C, 7B-8, 9B-10D, 11D).

In some aspects, the aperture is configured to decrease in size as the distance between the two sheets decreases.

In some aspects, a first sheet of the two sheets includes a wall (e.g., 1035), the wall on a first surface facing a second sheet of the two sheets and extending toward the second sheet. In some aspects, wherein the second sheet includes a slot (e.g., 1037), the slot on a second surface facing the first sheet and configured to receive the wall. In some aspects, deformable material is within an enclosure (e.g., 1039) formed by the wall within the slot. In some aspects, the deformable layer expands in the enclosure responsive to the distance between the two sheets decreasing (e.g., the deformable layer 1015 expanding in the yz-plane in FIG. 10A). In some aspects, at a first distance between the two sheets, the aperture is circular; and at a second distance between the two sheets, the aperture is oval (e.g., see FIG. 10B and related description).

Other aspects include components, devices, systems, improvements, methods, processes, applications, computer readable mediums, and other technologies related to any of the above.

### Variable Optical Aperture by Stretching Elastic Materials

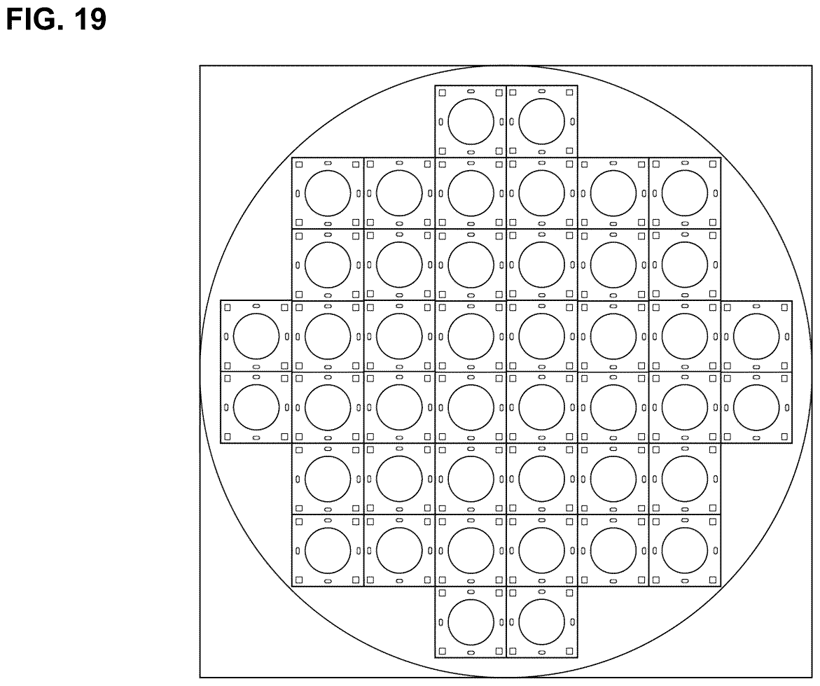

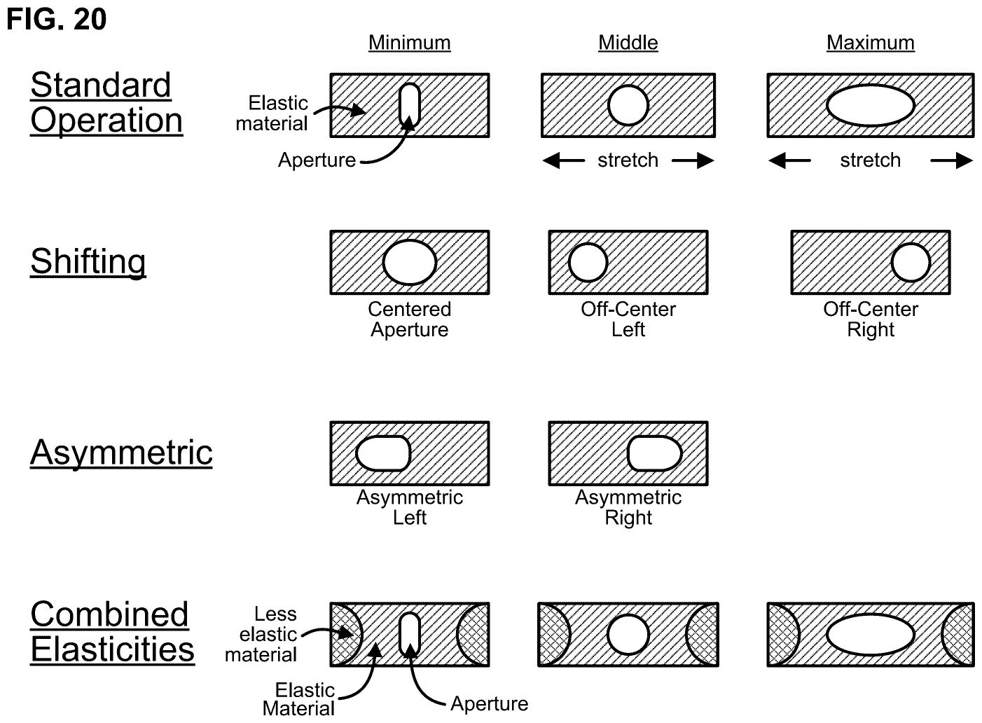

A variable optical aperture may be formed by a substantially opaque elastic material (e.g., a strip of material) with a (e.g., oval or circular) hole, anchored on two opposing sides. One or more anchored sides are attached to a motor (e.g., actuator) that may stretch the material to enlarge the hole, thus increasing the aperture size. For example, see the diagrams labeled “standard operation” in FIG. 20.

If two or more motors are used, the aperture can be moved across the optical path, providing a way to alter the perspective on the scene. For example, see the diagrams labeled “Shifting” in FIG. 20. This may be used for stereo depth calculations. This may additionally or alternatively be used for a form of image stabilization, where the aperture moves to counteract movement of the imaging system (e.g., 101). In some embodiments, the aperture may be moved using only one motor, however the aperture material may be non-elastic instead of elastic.

If two or more motors are used and the elastic material is anchored in the center, the elastic material can be stretched asymmetrically, allowing nontraditional aperture shapes to be formed. For example, see the diagrams labeled “Asymmetric” in the FIG. 20.

It may be beneficial to include non-elastic, or less elastic, material to control how the material stretches. This can be used to control the shape of the aperture as it stretches. For example, see the diagrams labeled “Combined Elasticities” in FIG. 20.

Some embodiments relate to an imaging system comprising: an image sensor; a substantially opaque elastic material forming an aperture along an optical path of the imaging system; and a motor system coupled to one or more sides of the material and configured to move one or both sides of the elastic material, wherein movement of one or both sides of the elastic material adjusts a shape and/or size of the aperture; and a controller (e.g., 113) configured to control the image sensor and the motor system.

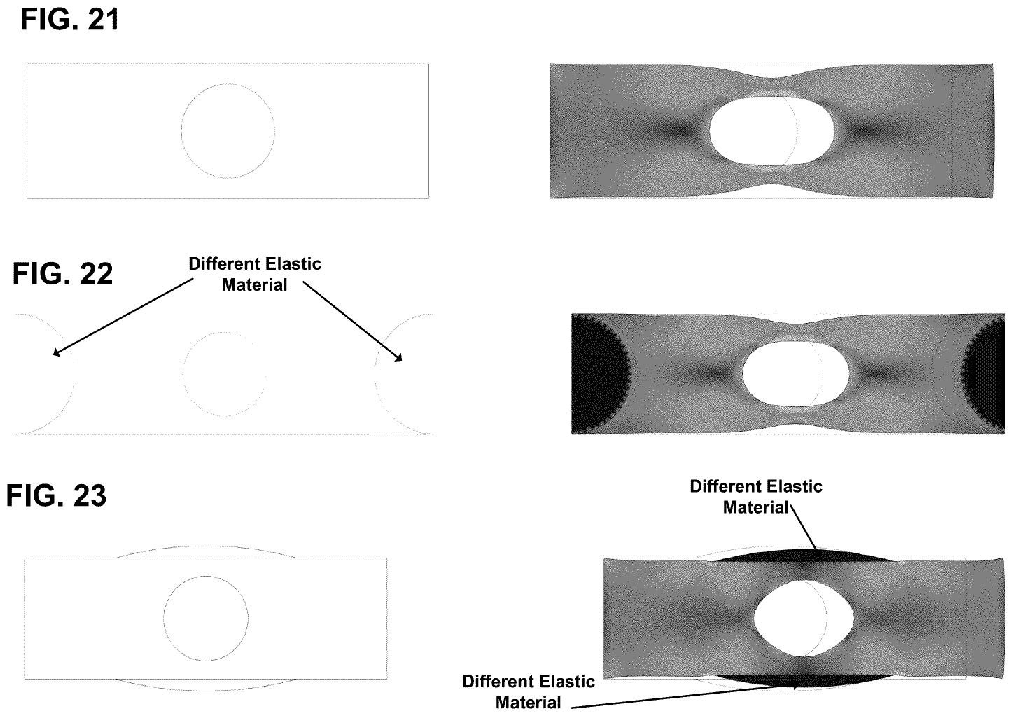

FIGS. 21-26 are diagrams of example strips of elastic materials that may be used to form a variable aperture, according to one or more embodiments. The left diagram of each figure illustrates the shape of the example elastic material unstretched. The right diagram of each figure illustrates the shape the example elastic material unstretched (the unstreched material is outlined as well for comparison. In these examples, the left side of each strip remains stationary while the right side is stretched (e.g., by a motor).

In FIG. 21, the left aperture is circular and the right aperture is an oval shape (thus, stretching the elastic material changes the shape of the aperture.

In some embodiments, the strip includes a combination of materials with different elastic properties. This may result in greater control over the shape of the aperture when the strip is stretched. FIGS. 22-23 are examples of this.

In FIG. 22, the left and right ends of the strip (indicated by the semicircles) include material with a different elasticity than the material of the rest of the strip. In this example, the ends include stiffer material. Due to the shape of the material at the ends (semicircles), the top and bottoms regions of the strip stretch more than the middle portion, resulting in a differently shaped oval.

In FIG. 23, the strip includes material with a different elasticity on the top and bottom sides (indicated by the semicircles), resulting in a differently shaped aperture.

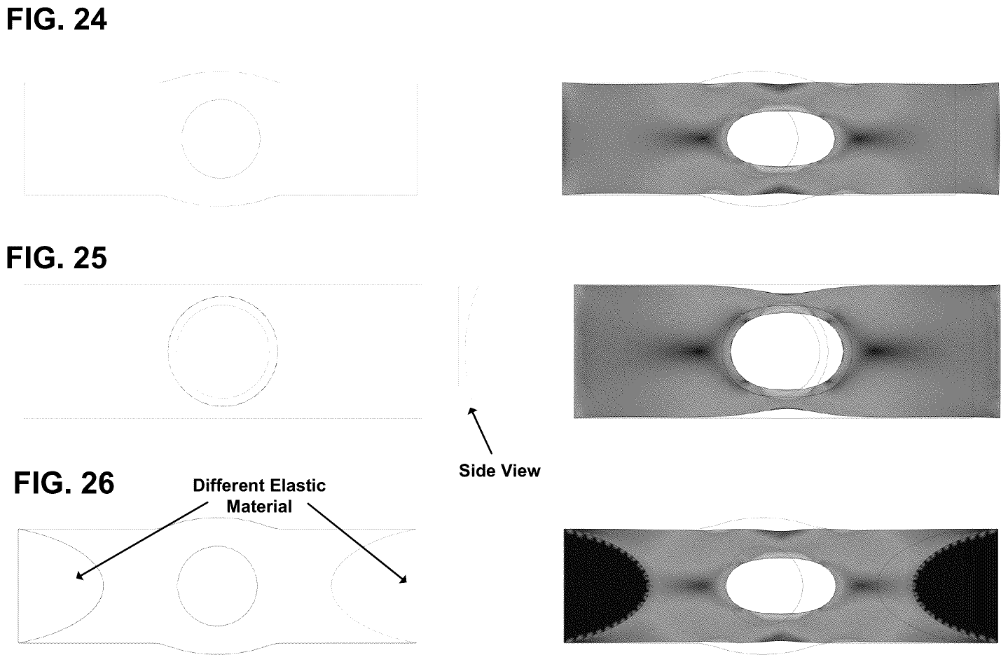

In FIG. 24, the strip has a non-uniform height near the aperture, resulting in a differently shaped aperture. The changing height changes the effective stiffness of the strip.

In FIG. 25, the strip has a non-uniform thickness as indicated by the side view, resulting in a differently shaped aperture.

A strip may have any combination of the features of the strips previously described and illustrated. For example, FIG. 25 illustrates a strip with a non-uniform height (similar to FIG. 24) and with the left and right ends of the strip including material with a different elasticity than the material of the rest of the strip. In this example, the ends include stiffer material.

### Example Machine Architecture

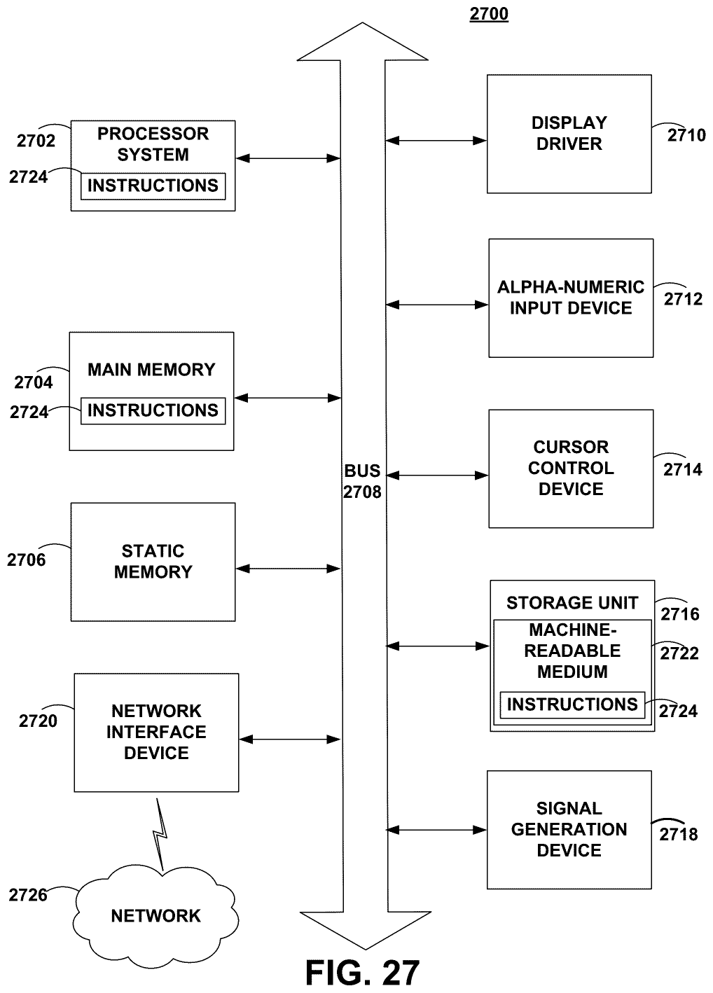

Referring now to FIG. 27, FIG. 27 is a block diagram illustrating components of an example machine able to read instructions from a machine-readable medium and execute them in a processor system. Specifically, FIG. 27 shows a diagrammatic representation of a computer system 2700 (also “computing system”). Imaging systems described herein (e.g., 101, 301) may be computer systems and thus may include one or more (or all) of the components and/or functionalities described with respect to FIG. 27. The computer system 2700 can be used to execute instructions 2724 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a standalone device with processing components having a processor system and a storage as described below. The machine also may be part of a system that includes a device coupled with a server computer, a client computer, a personal computer (PC), a tablet PC, a set-top box (STB), a smartphone, an internet of things (IoT) appliance, or any machine capable of executing instructions 2724 (sequential or otherwise) that specify actions to be taken by that machine and that may be have a small volumetric area within which to incorporate an imaging system as described herein. Further, while only a single machine is illustrated, the term “machine” shall also be taken to include any collection of machines that individually or jointly execute instructions 2724 to perform any one or more of the methodologies discussed herein. The instructions may be, for example, instructions for controlling the imaging systems, the adjustable aperture modules, the adjustable filter modules, and the adjustable aperture and filter modules described with respect to the previous figures.

The example computer system 2700 includes a processor system 2702 that includes one or more processing units (e.g., processors). If the processor system 2702 includes multiple processing units, the units may perform operations individually or collectively. The processor system 2702 is, for example, a central processing unit (CPU), a graphics processing unit (GPU), a digital signal processor (DSP), a controller, a state machine, an application specific integrated circuit (ASIC), a radio-frequency integrated circuit (RFIC), or any combination of these. The computer system 2700 also includes a main memory 2704. The computer system may include a storage unit 2716. The processor 2702, memory 2704 and the storage unit 2716 communicate via a bus 2708.

In addition, the computer system 2700 can include a static memory 2706, a display driver 2710 (e.g., to drive a plasma display panel (PDP), a liquid crystal display (LCD), or a projector). The computer system 2700 may also include alphanumeric input device 2712 (e.g., a keyboard), a cursor control device 2714 (e.g., a mouse, a trackball, a joystick, a motion sensor, or other pointing instrument), a signal generation device 2718 (e.g., a speaker), and a network interface device 2720, which also are configured to communicate via the bus 2708.

The storage unit 2716 includes a (e.g., non-transitory) machine-readable medium 2722 on which is stored instructions 2724 (e.g., software) embodying any one or more of the methodologies or functions described herein. The instructions 2724 may also reside, completely or at least partially, within the main memory 2704 or within the processor system 2702 (e.g., within a processor's cache memory) during execution thereof by the computer system 2700, the main memory 2704 and the processor system 2702 also constituting machine-readable media. The instructions 2724 may be transmitted or received over a network 2726 via the network interface device 2720.

While machine-readable medium 2722 is shown in an example embodiment to be a single medium, the term “machine-readable medium” should be taken to include a single medium or multiple media (e.g., a centralized or distributed database, or associated caches and servers) able to store the instructions 2724. The term “machine-readable medium” shall also be taken to include any medium that is capable of storing instructions 2724 for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, the controller module 113 and the controller module described with respect to FIG. 3A. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor system 2702, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment,” “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for forming a combined image through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. An imaging system comprising:
an image sensor;
two sheets along an optical path of the imaging system, the two sheets being substantially transparent; and
a deformable layer between the two sheets, the deformable layer forming an aperture, the aperture limiting light incident on the image sensor; and
a motor coupled to at least one of the two sheets, the motor configured to adjust a distance between the two sheets, wherein the size of the aperture is based on the distance between the two sheets.

2. The imaging system of claim 1, further comprising:
an additional sheet along the optical path of the imaging system; and
an additional deformable layer between the additional sheet and a first sheet of the two sheets.

3. The imaging system of claim 2 wherein the additional sheet and the additional deformable layer are substantially transparent.

4. The imaging system of claim 3, wherein to adjust the distance between the two sheets, the motor is configured to move the first sheet along the optical path and between the additional sheet and a second sheet of the two sheets.

5. The imaging system of claim 4, wherein to adjust the distance between the two sheets, the motor is not configured to send a control signal to the additional sheet or the second sheet.

6. The imaging system of claim 4, wherein a combined length of the two sheets, the deformable layer, the additional sheet, and the additional deformable layer remains constant.

7. The imaging system of claim 1, wherein a first portion of the deformable layer is substantially opaque and a second portion of the deformable layer is substantially transparent.

8. The imaging system of claim 1, wherein the deformable layer includes: a first material that is substantially opaque and that includes a hole which forms the aperture.

9. The imaging system of claim 8, wherein the deformable layer further includes: a second material that is substantially transparent and in the hole of the first material.

10. The imaging system of claim 1, wherein a first sheet of the two sheets includes a protrusion on a surface that faces a second sheet of the two sheets.

11. The imaging system of claim 10, wherein the protrusion is configured to press against the second sheet.

12. The imaging system of claim 10, wherein the protrusion has a conical shape.

13. The imaging system of claim 11, wherein the aperture is formed by the protrusion pressing against the second sheet and displacing the deformable layer.

14. The imaging system of claim 1, wherein the aperture is configured to increase in size as the distance between the two sheets decreases.

15. The imaging system of claim 1, wherein the aperture is configured to decrease in size as the distance between the two sheets decreases.

16. The imaging system of claim 1, wherein a first sheet of the two sheets comprises a wall, the wall on a first surface facing a second sheet of the two sheets and extending toward the second sheet.

17. The imaging system of claim 16, wherein the second sheet comprises a slot, the slot on a second surface facing the first sheet and configured to receive the wall.

18. The imaging system of claim 17, wherein deformable material is within an enclosure formed by the wall within the slot.

19. The imaging system of claim 18, wherein the deformable layer expands in the enclosure responsive to the distance between the two sheets decreasing.

20. The imaging system of claim 18, wherein:
at a first distance between the two sheets, the aperture is circular; and
at a second distance between the two sheets, the aperture is oval.
